(19) United States
(12) Patent Application Publication
(10) Pub. No.: US 2026/0204133 A1
(43) Pub. Date: Jul. 16, 2026

(54) ELECTRONIC WALLET SYSTEM AND PROCESS MANAGEMENT SYSTEM

(71) Applicants: Chris Popescu, Sterling Heights, MI (US); Bryan Thaqi, West Hollywood, CA (US); Thomas Hayes, Dallas, TX (US)

(72) Inventors: Chris Popescu, Sterling Heights, MI (US); Bryan Thaqi, West Hollywood, CA (US); Thomas Hayes, Dallas, TX (US)

(21) Appl. No.: 18/809,282

(22) Filed: Aug. 19, 2024

Related U.S. Application Data
(60) Provisional application No. 63/533,623, filed on Aug. 19, 2023.

(51) Int. Cl. G07F 17/32; G06Q 20/36

(52) U.S. Cl. CPC G07F 17/3248; G06Q 20/36

(57) ABSTRACT

A casino related services system comprising a wallet server coupled to a wallet server memory, the wallet server memory having registration requests and authorization responses. The wallet server parses the one or more registration requests using at least one casino gaming schema, sends the registration requests to an acquirer entity, an issuer entity, or both, receives authorization responses, parses the authorization responses using authorization response schema(s), creates a wallet account for each authorization response using the casino gaming schema and registration requests, the authorization responses, or both; creates casino related fungible data for each wallet account, the casino related fungible data having a value determined by, at least, an amount authorized by an issuer entity, and parses each wallet account using the at least one casino gaming schema, and sends each wallet account to an intended wallet recipient associated with a wallet client.

### CROSS REFERENCE TO RELATED APPLICATION

This application claims priority to U.S. Provisional Application No. 63/533,623, filed Aug. 19, 2023, the contents of which are incorporated herein by reference.

### FIELD OF THE DISCLOSURE

The present disclosure relates to information and communications technology, gaming, betting or bookmaking, and, more particularly, live and online gaming events, data security, data quality, risk-based compliance, and electronic wallets containing money units.

### BACKGROUND

Casinos are a type of business that relies heavily on cash for daily business operations. Casino players that require large amounts of cash to fund their gaming activities understand there is a level of risk involved to their safety. Casino players considered high rollers or those involved in high stakes cash games, such as poker, may face considerably more risk. Traditionally, these types of players may carry around half of a million dollars to these types of high stakes events.

As an example, a player may register for a particular high stakes event, travel to the casino carrying a large amount of cash, provide identification credentials to a casino representative, and have the cash deposited in a casino vault or security box. In the scenario above, the player runs the risk of the cash being confiscated by local or federal authorities, e.g., the Transportation Security Administration (TSA(R)), misplaced, lost, or stolen.

As can be seen, there is a need for a system and method that can eliminate the risk and danger posed to casino players involved in carrying cash or other valuables needed to satisfy buy in requirements of high stakes casino gaming events.

### BRIEF DESCRIPTION OF THE DRAWINGS

The drawings illustrate generally, by way of example, but not by way of limitation, various embodiments discussed in the present document.

FIG. 1 shows a diagram of an example system for operations management systems and electronic wallet systems, in accordance with one or more examples of the present disclosure, in accordance with certain aspects of the present disclosure.

FIG. 2A shows a block diagram of a computing environment and its application processes for one or more of the system devices of FIG. 1, in accordance with certain aspects of the present disclosure.

FIG. 2B shows a block diagram of a runtime environment and its tasks and threads for one or more of device systems of FIG. 1, in accordance with certain aspects of the present disclosure.

FIG. 3A shows an illustration of a signaling diagram for a method and process to securely register a wallet client account for a gaming tournament, transfer electronic funds to the wallet client account, and tokenize the funds, in accordance with certain aspects of the present disclosure.

FIG. 3B shows an illustration of a signaling diagram for a method and process to securely transfer tokenized funds to a casino wallet account to satisfy buy-in requirements for the gaming tournament, in accordance with certain aspects of the present disclosure.

FIG. 4A shows an illustration of a computer algorithm or model having various instructions for performing one or more of the methods and processes disclosed in FIGS. 1-3, in accordance with certain aspects of the present disclosure.

FIG. 4B shows an illustration of a computer algorithm or model comprising various instructions for performing one or more of the methods and processes disclosed herein, in accordance with aspects of the present disclosure.

### DETAILED DESCRIPTION

As previously stated, high-stakes gaming events, such as blackjack, video poker, craps, etc., often require large cash buy-ins; for example, the US Poker Open is a series of 12 high-stakes poker events with buy-ins ranging between $10,000 to $50,000. However, players will often carry on their person perhaps 10 or 20 times the required buy-ins. It is not uncommon for a serious player to go to these events carrying $150,000 to $500,000.

A particular problem with this is that it puts a player at risk of harm or at the mercy of unscrupulous authority figures. It is never a good idea to carry large amounts of cash. And it is particularly not a good idea to do so in a conspicuous manner. However, players that gamble professionally, and particularly ones that have a high profile, can become easy targets for those with ill intent.

Other problems are that a sponsor of the tournament may be obligated to provide security at the event, and the player may carry protection, e.g., a pistol, or may hire his or her own security detail. Although this may be effective most of the time, it adds time, expense, and can possibly places others in harm's way.

Further, casinos large enough to be considered financial institutions are beginning to offer what are considered traditional banking services. However, these casinos, in general, do not implement the procedures, policies, technology, and personnel that some of the larger, more well-known banks do. This can be evidenced by recent cyberattacks that resulted in 6 terabytes of data stolen from MGM Resorts International® and Caesars Entertainment®. This is just one instance of several attacks that have recently taken place. MGM Resorts International® recently confirmed that millions of customer records were stolen after hackers breached their cloud services. These types of attacks have an immediate and long-term impact affecting a company financially, reputationally, and legally.

A particular problem for the institutions is that the attacks are often the result of sensitive IT system information being compromised. This is typically due to the act of an employee who is either compromised or is duped in some manner by giving sensitive information to the wrong person. This can be particularly problematic for a company that does business within the European Union (EU). Companies that do business in the EU must follow a legal framework known as the General Data Protection Regulation (GDPR) when handling consumer data. If there is a data breach, companies are required to notify customers within a set time.

There is evidence from law enforcement and other agencies that many of these companies do not report when there is a breach, but rather try to manage the situation internally. Often it is the attackers that make the public aware by, e.g., dumping stolen content on a hackers'forum. This may be due to the company not paying a ransom or simply out of spite.

### Overview

In the following disclosure, an overview and a detailed discussion of the disclosure are provided. The overview is provided as a summary of certain aspects of the disclosure. A detailed discussion follows the overview and includes a description of the illustrative embodiments. The overview is not intended to identify key features or essential features, nor is it intended to be used to limit the scope of the claimed subject matter. It presents some concepts in a simplified form as a prelude to the more detailed disclosure of the various use cases and the sections entitled “System,” “Enterprise-System Devices,” “Enterprise and Enterprise-Consumer System Devices,” “Enterprise, Enterprise-Consumer, and 3rd Party System Devices,” “Network Infrastructure System Devices,” “System Device, Device Systems Profiles,” “Computing Environment and Runtime Environment,” “Signaling Diagrams,” and “Methods of Operation.” Presented herein are systems and methods for managing gaming data in a manner that improves player and personnel safety, data quality, and data security. A wallet client system, a wallet server system, a security system, a location-based services system, and various other system services are disclosed and used to address the previously described problems.

In one aspect, a system is integrated with and communicably coupled with casino related services. The system comprises a processor and a memory communicably coupled to the processor. The memory includes stored therein one or more registration requests, one or more authorization responses, and one or more instructions.

The processor executes instruction that cause the processor to: parse the one or more registration requests using at least one casino gaming schema, and send the one or more registration requests to an acquirer entity, an issuer entity, or both; receive one or more authorization responses, parse the one or more authorization responses using one or more authorization response schemas; create a wallet account for each authorization response using the at least one casino gaming schema and the one or more registration requests, the one or more authorization responses, or both; create casino related fungible data for each wallet account, the casino related fungible data having a value determined by, at least, an amount authorized by an issuer entity; parse each wallet account using the at least one casino gaming schema; and send each wallet account to an intended wallet recipient.

In some aspects, the system further comprises a wireless router processor communicably coupled to a wireless router memory, the wireless router memory having one or more received signals, and comprising a set of instructions that cause the wallet router processor to: measure one or more components of each received signal to determine location of the at least one point of transaction device, at least one proximity sensor device, at least one mobile device, the wallet server processor, or any combination thereof.

In other aspects, the system further comprises a proximity sensor processor communicably coupled to a proximity sensor memory, the proximity sensor memory having one or more received signals, and comprising a set of instructions that cause the proximity sensor processor to: send a coded signal to at least one wallet server, wherein the coded signal includes a wallet client identifier, a point of transaction device identifier, or both.

In yet other aspects, the set of instructions cause the wallet server processor to store the wallet account, and the casino related fungible data in a wallet server database. In still other aspects, the set of instructions cause the wallet server processor to the one or more registration requests using a known communication method of the acquirer or issuer entity; and each wallet account based on a known communication method of the wallet client.

In still yet other aspects, the casino gaming schema comprises acquirer entity communication protocol variables, acquirer entity processing variables, or both, and one or more of each of the following: location area identifier, a table identifier, a slot machine identifier, current location value, wallet account identifier, account value, debit identifier and value, credit identifier and value, marker identifier and value, loan identifier and value, or a combination thereof.

In other aspects, the casino related fungible data comprises restricted use variables that limit use of the casino related fungible data to a casino, location area of a casino, specific gaming tables of a casino, specific slot machines of a casino, online gaming applications, or any combination thereof.

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

### System

A casino may offer various gaming services, such as gaming machines, gaming tables, and online gaming services, and bookie services, cash exchange services, payment processing services, loan services, and hospitality services. Gaming services can include on-site gaming machines and gaming tables, and online virtual gaming machines and tables. Hospitality services can include, but are not limited to, hotel booking and hotel services, food and beverage services, event planning, gaming events, restaurants, nightclubs, and bars.

Operations management systems are units of a computing environment that support day-to-day casino operations. Operations management systems are enabled and operational to: monitor and record various casino activities; create, generate, control, and manage supply chains, inventories, customer relationships, marketing, and human resources; grant, control, and manage access to various facilities; create, generate, plan, control, and manage events; procure and manage loans; and render, provision, and manage online gaming systems, gaming tables, casino cages, and staff.

Secure systems are areas of a computing environment that are configured and operational to securely process and store data in performance of day-to-day casino exchanges and transactions. Secure systems can process data in one or more secure zones, using one or more domains, or one or more combinations thereof. Secure processing and storage systems can process structured data, unstructured data, hybrids of relational and non-relational data variables, or one or more combinations thereof. Secure processing and storage systems can store structured data, unstructured data, hybrids of relational and non-relational data variables, or one or more combinations thereof.

Secure processing and storage systems can create, generate, control, and manage sensitive data in one or more secure zones, using one or more security domains, or one or more combinations thereof. Secure processing and storage systems can store data in one or more secure zones, use one or more security domains, or one or more combinations thereof.

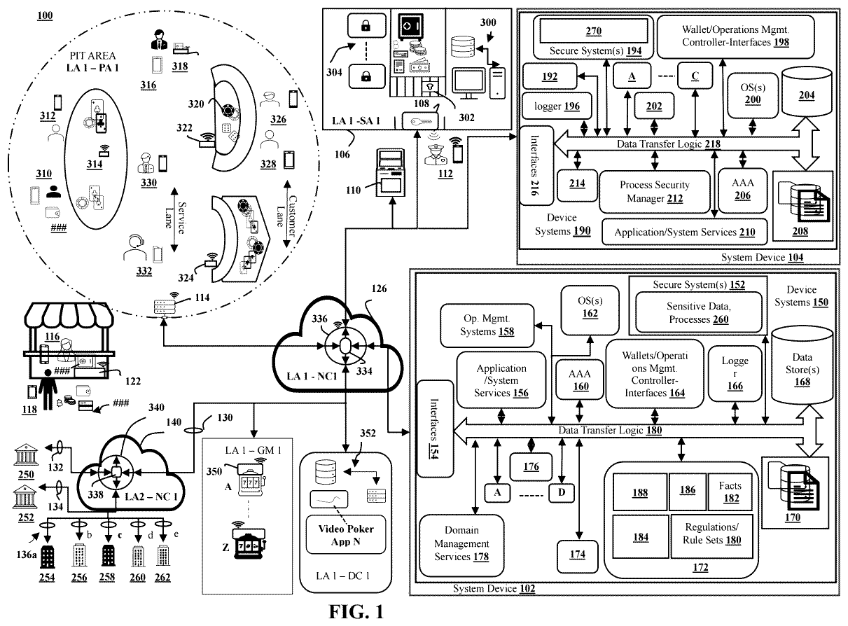

FIG. 1 is a diagram that shows an example system 100 for operations management systems and electronic wallet systems, in accordance with one or more examples of the present disclosure, denoted generally as 100. System 100 comprises system devices and device systems coded and configured for executing tasks in performance of managing and controlling credentials and payment elements related to and in association with various products and services provided through operations of a commercial or tribal casino.

The system devices and device systems can be operated by the casino, casino guests, 3^{rd} party entities, or vendors. One or more devices, one or more device systems, one or more applications, or one or more combinations thereof can be operated in an onsite data center, a remote data center, a remote 3rd party data center, or combinations thereof and managed by casino personnel or 3^{rd} party personnel. One or more device systems and one or more applications can be deployed and operated using 3^{rd} party hosting services. The one or more applications can be deployed and operated using 3^{rd} party application services, 3^{rd} party system services, 3^{rd} party data center and operations.

System 100 can comprise system device 102, system device 104, facility 106, system device 108, ATM device 110, system device 112, network node system device 114, system device 116, system device 118, system device 122, and network infrastructure system device 126. System 100 can further comprise interfaces 130, 132, 134, 136a through 136e, or one or more combinations thereof communicably coupled with network infrastructure 140.

### Enterprise—System Devices

System device 102 can include one or more processors, one or more processor cores, one or more Random Access Memory (RAM) devices, one or more non-volatile memory devices, one or more Secure Elements (SE), one or more Trusted Platform Modules (TPM), one or more Hardware Security Modules (HPM), one or more hard disk drives, one or more input devices, one or more output devices, or one or more combinations thereof.

System device 102 can comprise one or more CISC based processors, one or more RISC based processors, or one or more combinations thereof. System device 102 can comprise one or more CISC based processors, one or more RISC based processors, one or more CISC based processors configured to process one or more computer operations compiled for one or more RISC based processors. System device 102 can comprise one or more CISC based processors, one or more RISC based processors, one or more RISC based processors configured to process one or more computer operations compiled for one or more CISC based processors.

System device 102 can comprise one or more areas of one or more processors and one or more areas of memory, one or more areas of one or more processor cores and one or more areas of memory, or one or more combinations thereof comprising hardware designed to create one or more Trusted Execution Environments (TEEs). System device 102 can comprise one or more processors, one or more processor cores, or one or more combinations thereof configured, enabled, or both by an OS to perform cryptographic operations, such as encryption, decryption, key management, secure boot process, and memory encryption and memory isolation.

Device systems 150 can comprise secure system(s) 152, interfaces 154, application and system services 156, operations management systems 158, AAA 160, OS(s) 162, wallets and operations management controller and interfaces 164, logger 166, data store 168, in-memory processes, data 170, compliance controller 172, process security manager 174, bootloader 176, domain management services 178, and data transfer logic 180.

Device systems 150 can comprise one or more OSs installed on one or more partitions of RAM, one or more partitions of non-volatile memory, one or more file system partitions, or one or more combinations thereof. Device systems 150 can instantiate and execute one or more OSs loaded on one or more partitions of RAM, one or more partitions of non-volatile memory, one or more file system partitions, or one or more combinations thereof.

Device systems 150 can comprise one or more OSs compiled for use with one or more CISC based architectures. Device systems 150 can comprise one or more OSs compiled for use with one or more RISC based architectures. Device systems 150 can comprise one or more OSs cross compiled for use with one or more RISC architectures and one or more CISC architectures. Device systems 150 can comprise one or more programs coded and configured to schedule tasks and threads based on one or more TEEs in a computing environment.

Secure system(s) 152 comprises one or more secure runtime environments. A secure runtime environment is a secure execution context of a computing environment that protects tasks, threads, and data from unauthorized access and tampering by isolating them from the rest of the computing environment. The secure execution context can include hardware mechanisms, software mechanisms, or both.

Secure system(s) 152 can include one or more TEEs, one or more SEs, one or more SoCs, one or more TPMs, one or more HSMs, one or more virtual machines, one or more virtual containers, or one or more combinations thereof. Secure system(s) 152 can include one or more SEs, one or more SoCs, one or more TPMs, one or more HSMs, one or more virtual machines, one or more virtual containers, or one or more combinations thereof implemented within a TEE. A TEE can include one or more secure enclaves, one or more isolated enclaves, or one or more combinations thereof.

Secure system(s) 152 can include, but are not limited to, one or more processors, one or more processor cores, one or more units of memory, one or more memory regions, one or more input devices, one or more output devices, one or more peripherals, one or more network interface cards, one or more memory partitions, one or more disk partitions, one or more input controllers, one or more output controllers, or one or more combinations thereof.

Secure system(s) 152 can comprise one or more OSs compiled or cross compiled to work with one or more CISC based processors, one or more RISC based processors, one or more ASICS, or one or more combinations thereof. Secure system(s) 152 can comprise one or more OSs compiled for and installed on one or more RAM partitions, one or more non-volatile memory partitions, one or more disk partitions, or one or more combinations thereof. Secure system(s) 152 can comprise one or more OSs loaded to, instantiated in, and executed from one or more RAM partitions, one or more non-volatile memory partitions, one or more disk partitions, or one or more combinations thereof.

Secure system(s) 152 can comprise one or more OSs transportable between one or more RAM partitions, one or more non-volatile memory partitions, one or more disk partitions, or one or more combinations thereof. Secure system(s) 152 can comprise one or more OSs configurable and transportable between one or more RAM partitions, one or more non-volatile memory partitions, one or more disk partitions, or one or more combinations thereof.

One or more units of memory can include units of RAM, non-volatile memory, or one or more combinations thereof. One or more memory regions can include regions of RAM, regions of non-volatile memory, or one or more combinations thereof. The one or more units of RAM, one or more regions of non-volatile memory, or one or more combinations thereof can be memory of one or more central processors, one or more central processor cores, one or more input devices, one or more output devices, one or more peripherals, one or more network interface cards, one or more output controllers, or one or more combinations thereof.

Secure system(s) 152 can instantiate one or more applications, one or more application programs, or one or more combinations thereof, and execute one or more tasks, execute one or more threads, or one or more combinations thereof, and perform one or more computer operations in a secure runtime execution environment using an OS shared with one or more application processes and one or more runtime execution environments of a computing environment.

Secure system(s) 152 can instantiate one or more applications, one or more application programs, or one or more combinations thereof, and execute one or more tasks, execute one or more threads, or one or more combinations thereof, and perform one or more computer operations in a secure runtime execution environment using a separate OS than one or more OSs of a runtime execution environment of a computing environment.

The one or more applications, one or more application programs, or one or more combinations thereof can include, but are not limited to, boot processes, scheduling processes, minting processes, surveillance processes, reporting processes, encryption processes, decryption processes, data storage processes, controller processes, security management processes, etc.

Secure system(s) 152 can communicate (send and receive) one or more application identifiers, one or more process identifiers, one or more tasks, one or more threads, or one or more combinations thereof with one or more application processes external to secure system(s) 152 using one or more interfaces, one or more protocols, and one or more interface mediums.

Secure system(s) 152 can communicate one or more application identifiers, one or more process identifiers, output of one or more executed tasks, output of one or more executed threads, or one or more combinations thereof to one or more application processes external to secure system(s) 152 using one or more interfaces, one or more protocols, and one or more interface mediums.

The one or more application processes external to secure system(s) 152 can include interfaces 154, application and system services 156, operations management systems 158, AAA 160, OS(s) 162, wallets and operations management controller and interfaces 164, logger 166, data store 168, in-memory processes, data 170, compliance controller 172, process security manager 174, bootloader 176, domain management services 178, and data transfer logic 180, or one or more combinations thereof.

Secure system(s) 152 can use one or more interfaces, one or more protocols, one or more interface mediums, or one or more combinations thereof to communicate tasks, threads, or both with one or more units of memory using data transfer logic 180 of a bridge, bus, bridge bus, DMA controller, or one or more combinations thereof.

Secure system(s) 152 can use one or more interfaces, one or more protocols, one or more one or more interface mediums, or one or more combinations thereof to communicate tasks, threads, or both with one or more regions of memory using data transfer logic 180 of a bridge, bus, bridge bus, DMA controller, or one or more combinations thereof.

Secure system(s) 152 can use one or more interfaces, one or more protocols, one or more interface mediums, or one or more combinations thereof to communicate one or more application identifiers, one or more process identifiers, output of one or more executed tasks, output of one or more executed threads, or one or more combinations thereof with one or more units of memory using data transfer logic 180 of a bridge, bus, bridge bus, DMA controller, or one or more combinations thereof.

Secure system(s) 152 can use one or more interfaces, one or more protocols, one or more one or more interface mediums, or one or more combinations thereof to communicate one or more application identifiers, one or more process identifiers, output of one or more executed tasks, output of one or more executed threads, or one or more combinations thereof with one or more regions of memory using data transfer logic 180 of a bridge, bus, bridge bus, DMA controller, or one or more combinations thereof.

Interfaces 154 comprise one or more programs to select one or more points of contact and communicate data pursuant to one or more protocols using one or more interface mediums.

Data transfer logic 180 comprises address, data, and control logic for one or more buses, one or more bridges, one or more Direct Memory Access (DMA) controllers, or combinations thereof. A bus or bridge can provide means for communicating data between various device components, such as processors, processor cores, microcontrollers, memory, input devices, output devices, and peripherals. A DMA controller can request control of part of a bridge or bus to communicate data between two devices, such as an embedded system and a SoC, a SoC and a Network Interface Card, an embedded system and a TEE.

Application and system services 156 comprise various user applications, system applications, modules, device drivers, and files that can be called to access and use one or more service-based tasks in support of one or more calling applications. Application services can include web servers, databases, application servers, network infrastructure, middleware, etc.

System services can include memory management, process scheduling, file system management, device drivers, and security services.

Operations management systems 158 comprise one or more application protocol interfaces to securely manage data from one or more security policy and procedure applications, one or more service policy and procedure applications, one or more supply chain management applications, one or more enterprise resource planning applications, one or more human resource management applications, one or more customer relationship management applications, or one or more combinations thereof.

AAA 160 comprises one or more applications to authenticate user credentials, system credentials, and group credentials associated with accounts of an OS. AAA 160 also comprises one or more applications to authorize authenticated user credentials, system credentials, and group credentials associated with accounts of an OS. AAA 160 also comprises one or more applications to account for system use of authenticated and authorized user credentials, system credentials, and group credentials associated with accounts of an OS.

OS(s) 162 can comprise one or more kernel(s) compiled for use with CISC architecture or RISC architecture. OS(s) 162 can comprise one or more kernels cross compiled for use with CISC architecture and RISC architecture.

Wallet and operations management controller and interfaces 164 can communicate with secure system(s) 152 and operations management systems 158 using one or more interfaces, one or more interface mediums, or both. Wallet and operations management controller and interfaces 164 can comprise instructions for communicating with operations management systems 158, secure systems 152, or both using one or more protocols, one or more link addresses, such as a Medium Access Control (MAC) address, one or more network addresses, one or more transport identifiers, one or more application identifiers, or one or more combinations thereof.

Logger 166 comprises one or more logging facilities with each facility configured to monitor a message type or message types, filter all messages of a message type or select messages of a message type based on criterion or criteria, and store the filtered messages.

Data store(s) 158 can comprise one or more applications, one or more file systems, one or more databases, or one or more combinations thereof installed on one or more partitions of RAM, one or more partitions of non-volatile memory, one or more file system partitions, or one or more combinations thereof. Data store 168 can instantiate and execute one or more OSs loaded on one or more partitions of RAM, one or more partitions of non-volatile memory, or one or more combinations thereof.

Data store(s) 158 can communicate with the one or more file systems, one or more databases, or one or more combinations thereof using one or more device identifiers, one or more network addresses, one or more loopback addresses, one or more transport identifiers, one or more application identifiers, one or more application process identifiers, one or more interfaces, one or more protocols, one or more interface mediums, or one or more combinations thereof.

Data store(s) 158 can communicate with one or more user applications, one or more system applications, one or more group applications using one or more device identifiers, one or more network addresses, one or more loopback addresses, one or more transport identifiers, one or more application identifiers, one or more application process identifiers, one or more interfaces, one or more protocols, one or more interface mediums, or one or more combinations thereof.

In-memory processes, data 170 can comprise one or more memory identifiers and for each area of memory associated with an identifier the memory area can comprise tasks, threads, and variables and output of application processes created by or created for various applications and processes of device systems 150. These various applications and processes can include, but are not limited to, one or more applications of secure system(s) 152, interfaces 154, application and system services 156, operations management systems 158, AAA 160, OS(s) 162, wallet and operations management controller and interfaces 164, logger 166, data store 168, compliance controller 172, process security manager 174, domain management services 178, or one or more combinations thereof.

Compliance controller 172 comprises regulations and rule sets 180, facts 182, interfaces 184, policies schema 186, and process schema 188. Regulations and rule sets 172 comprise regulations and rules that govern casino gaming operations within multiple jurisdictions. The jurisdictions can include federal, state, county, and city, or any combination thereof. The regulations and rules that govern casino gaming operations can also include regulation requirements for foreign jurisdictions as well.

Facts 182 are data that have been identified as relevant to one or more schemas based on regulations and rule sets 180, other facts, interfaces 184, policies schema 186, and process schema 188. Data can be generated or provided by one or more processes herein. Facts 174 are variables with a parameter and one or more values, a field in a database table, a row in a database table, or any combination thereof. Facts 172 are data in-memory processes, data 170, data store 168, logger 166, or any combination thereof.

Compliance controller 172 comprises one or more programs coded and configured to access various sources of data using interfaces 184 and harvest facts 182 using one or more schemas based on regulations and rule sets 180, other facts, interfaces 184, policies schema 186, and process schema 188.

Compliance controller 172 can monitor, identify, evaluate, calculate, determine, or any combination thereof data stored in-memory processes, data 170, data store 168, logger 166, or any combination thereof pursuant to regulations and rule sets 172. Compliance controller 172 can create data sets based on monitored, identified, evaluated, calculated, determined, or any combination data thereof pursuant to policies schema 178 and process schema 140. Compliance controller 172 can store, process, and communicate data set state pursuant to regulations and rule sets 180.

Process security manager 174 can be used by one or more application programs to store data, store sensitive data, process data, process sensitive data, communicate data, communicate sensitive data, or one or more combinations thereof. Process security manager 174 can be used by one or more applications or application programs to store data, store sensitive data, process data, process sensitive data, communicate data, communicate sensitive data, or combinations thereof pursuant to one or more security domains, one or more standards, one or more rules, one or more policies, one or more procedures, one or more protocols, or one or more combinations thereof.

Process security manager 174 can create a security domain and associate one or more user accounts, one or more system accounts, one or more group accounts, or one or more combinations thereof. Process security manager 174 can associate one or more applications, application programs, or both to a security domain. Process security manager 174 can associate one or more link identifiers, one or more network identifiers, one or more fully qualified domain names, one or more communication addresses, one or more communication numbers, or one or more combinations thereof to a security domain.

Process security manager 174 can associate one or more location variables, one or more location fields, one or more location rows, or one or more combinations thereof to a security domain. Process security manager 174 can associate one or more proximity variables, one or more proximity fields, one or more proximity rows, or one or more combinations thereof to a security domain. Process security manager 174 can associate one or more access tokens, one or more access privileges, one or more authentication tokens, one or more authorizations, or one or more combinations thereof to a security domain Process security manager 174 can perform security checks of user applications, system applications, data stores, in-memory processes, or one or more combinations thereof. Process security manager 174 can perform backups of user applications, system applications, data stores, in-memory processes, or one or more combinations thereof.

Process security manager 174 can perform security checks of user applications, system applications, data stores, in-memory processes, or one or more combinations thereof using one or more schemas, one or more data sets, or both. Process security manager 174 can use one or more schemas, one or more trusted data sets, or one or more combinations thereof for performing data integrity and data quality checks of data set backups.

Process security manager 174 can determine user privileges, system privileges, or both of user applications, system applications, data stores, in-memory processes, or one or more combinations thereof. Process security manager 174 can determine data quality, data integrity, or both of user applications, system applications, data stores, in-memory processes, or one or more combinations thereof.

Process security manager 174 can analyze one or more application processes, one or more system processes, one or more device processes, or one or more combinations thereof and create a behavior analysis profile of one or more user applications, one or more system applications, one or more system devices, one or more user accounts, one or more system accounts, one or more group accounts, or one or more combinations thereof.

Process security manager 174 can enable and disable one or more security domains, one or more secure runtime execution environments, one or more runtime execution environments, or one or more combinations thereof. Process security manager 174 can enable or disable one or more domains, one or more execution environments, one or more secure execution environments, or one or more combinations thereof using one or more schemas, one or more data sets, or one or more combinations thereof.

Process security manager 174 can enable and disable one or more security domains, one or more secure execution environments, or one or more combinations thereof based on or more variables, one or more rows, one or more fields, one or more tables, or one or more combinations thereof. Process security manager 174 can enable and disable one or more security domains, one or more execution environments, one or more secure execution environments, or one or more combinations thereof using one or more schemas, one or more data sets, or one or more combinations thereof based on or more variables, one or more rows, one or more fields, one or more tables, or one or more combinations thereof.

Bootloader system 176, e.g., UEFI, comprises one or more processes enabled to load one or more bootloader programs, e.g., A through D, for each OS installed on system device 102. Each bootloader program, A through C, loads an OS, i.e., kernel on a root partition and executes init which in turn directly or indirectly spawns other system applications, user applications, etc. One or more bootloader programs, e.g., A through D, can be a secure bootloader program. One or more of the bootloader programs can be operated from one or more RoT. Each secure bootloader encrypts and decrypts an associated OS image using cryptographic algorithms and accelerators. Each secure bootloader authenticates each OS image and verifies the image's integrity using the cryptographic algorithms and accelerators.

Domain management services 178 can administer access, control access, and set privileges for users, groups, and others based on one or more security domains, one or more schemas, one or more data sets, or one or more combinations thereof. Domain management services 178 can administer access, control access, and set privileges for users, groups, and others based on one or more security domains and one or more variables, a change in one or more variables, one or more fields, one or more table rows, or one or more combinations thereof.

Data transfer logic 180 comprises address, data, and control logic for one or more buses, one or more bridges, one or more Direct Memory Access (DMA) controllers, or combinations thereof. A bus or bridge can provide means for communicating data between various device components, such as processors, processor cores, microcontrollers, memory, input devices, output devices, and peripherals. A DMA controller can request control of part of a bridge or bus to communicate data between two devices, such as an embedded system and a SoC, a SoC and a Network Interface Card, an embedded system and a TEE.

### Enterprise and Enterprise—Consumer System Devices

System device 104 can include one or more processors, one or more processor cores, one or more Random Access Memory (RAM) devices, one or more non-volatile memory devices, one or more Secure Elements (SE), one or more Trusted Platform Modules (TPM), one or more Hardware Security Modules (HPM), one or more hard disk drives, one or more input devices, one or more output devices, or one or more combinations thereof.

System device 104 can comprise one or more CISC based processors, one or more RISC based processors, or one or more combinations thereof. System device 104 can comprise one or more CISC based processors, one or more RISC based processors, one or more CISC based processors configured to process one or more computer operations compiled for one or more RISC based processors. System device 104 can comprise one or more CISC based processors, one or more RISC based processors, one or more RISC based processors configured to process one or more computer operations compiled for one or more CISC based processors.

System device 104 can comprise one or more areas of one or more processors and one or more areas of memory, one or more areas of one or more processor cores and one or more areas of memory, or one or more combinations thereof comprising hardware designed to create one or more Trusted Execution Environments (TEEs). System device 104 can comprise one or more processors, one or more processor cores, or one or more combinations thereof configured, enabled, or both by an OS to perform cryptographic operations, such as encryption, decryption, key management, secure boot process, and memory encryption and memory isolation.

Device systems 190 can comprise operations management systems 192, secure system(s) 194, logger 196, wallet and operations management controller and interfaces 198, OS(s) 200, bootloader system 202, bootloaders A-C, data store 204, AAA 206, in-memory processes, data 208, application and system services 210, process security manager 212, domain management services 214, interfaces 216, and data transfer logic 218.

Device systems 190 can comprise one or more OSs installed on one or more partitions of RAM, one or more partitions of non-volatile memory, one or more file system partitions, or one or more combinations thereof. Device systems 190 can instantiate and execute one or more OSs loaded on one or more partitions of RAM, one or more partitions of non-volatile memory, one or more file system partitions, or one or more combinations thereof.

Device systems 190 can comprise one or more OSs compiled for use with one or more CISC based architectures. Device systems 190 can comprise one or more OSs compiled for use with one or more RISC based architectures. Device systems 190 can comprise one or more OSs cross compiled for use with one or more RISC architectures and one or more CISC architectures. Device systems 190 can comprise one or more programs coded and configured to schedule tasks and threads based on one or more Trusted Execution Environments (TEEs) in a computing environment.

Depending on use case or profile, one or more applications or programs of device systems 190 may not be installed for each device of system 100. One or more installed applications or programs of device systems 190 may not be activated or may be disabled, depending on use case or profile. In addition, one or more device systems, one or more applications, or one or more programs may be operated as a server, client, headless server, peer to peer device, peer to peer network, peer to peer application, or one or more combinations thereof.

Operations management systems 192 comprise one or more application protocol interfaces to securely manage data from one or more security policy and procedure applications, one or more service policy and procedure applications, one or more supply chain management applications, one or more enterprise resource planning applications, one or more human resource management applications, one or more customer relationship management applications, or one or more combinations thereof.

Secure system(s) 194 comprises one or more secure runtime environments. A secure runtime environment is a secure execution context of a computing environment that protects tasks, threads, and data from unauthorized access and tampering by isolating them from the rest of the computing environment. The secure execution context can include hardware mechanisms, software mechanisms, or both.

Secure system(s) 194 can include one or more TEEs, one or more SEs, one or more SoCs, one or more TPMs, one or more HSMs, one or more virtual machines, one or more virtual containers, or one or more combinations thereof. Secure system(s) 194 can include one or more SEs, one or more SoCs, one or more TPMs, one or more HSMs, one or more virtual machines, one or more virtual containers, or one or more combinations thereof implemented within a TEE. A TEE can include one or more secure enclaves, one or more isolated enclaves, or one or more combinations thereof.

Secure system(s) 194 can include, but are not limited to, one or more processors, one or more processor cores, one or more units of memory, one or more memory regions, one or more input devices, one or more output devices, one or more peripherals, one or more network interface cards, one or more memory partitions, one or more disk partitions, one or more input controllers, one or more output controllers, or one or more combinations thereof.

Secure system(s) 194 can comprise one or more OSs compiled or cross compiled to work with one or more CISC based processors, one or more RISC based processors, one or more ASICS, or one or more combinations thereof. Secure system(s) 194 can comprise one or more OSs compiled for and installed on one or more RAM partitions, one or more non-volatile memory partitions, one or more disk partitions, or one or more combinations thereof. Secure system(s) 194 can comprise one or more OSs loaded to, instantiated in, and executed from one or more RAM partitions, one or more non-volatile memory partitions, one or more disk partitions, or one or more combinations thereof.

Secure system(s) 194 can comprise one or more OSs transportable between one or more RAM partitions, one or more non-volatile memory partitions, one or more disk partitions, or one or more combinations thereof. Secure system(s) 194 can comprise one or more OSs configurable and transportable between one or more RAM partitions, one or more non-volatile memory partitions, one or more disk partitions, or one or more combinations thereof.

One or more units of memory can include units of RAM, non-volatile memory, or one or more combinations thereof. One or more memory regions can include regions of RAM, regions of non-volatile memory, or one or more combinations thereof. The one or more units of RAM, one or more regions of non-volatile memory, or one or more combinations thereof can be memory of one or more central processors, one or more central processor cores, one or more input devices, one or more output devices, one or more peripherals, one or more network interface cards, one or more output controllers, or one or more combinations thereof.

Secure system(s) 194 can instantiate one or more applications, one or more application programs, or one or more combinations thereof, and execute one or more tasks, execute one or more threads, or one or more combinations thereof, and perform one or more computer operations in a secure runtime execution environment using an OS shared with one or more application processes and one or more runtime execution environments of a computing environment.

Secure system(s) 194 can instantiate one or more applications, one or more application programs, or one or more combinations thereof, and execute one or more tasks, execute one or more threads, or one or more combinations thereof, and perform one or more computer operations in a secure runtime execution environment using a separate OS than one or more OSs of a runtime execution environment of a computing environment.

The one or more applications, one or more application programs, or one or more combinations thereof can include, but are not limited to, boot processes, scheduling processes, minting processes, surveillance processes, reporting processes, encryption processes, decryption processes, data storage processes, controller processes, security management processes, etc.

Secure system(s) 194 can communicate (send and receive) one or more application identifiers, one or more process identifiers, one or more tasks, one or more threads, or one or more combinations thereof with one or more application processes external to secure system(s) 194 using one or more interfaces, one or more protocols, and one or more interface mediums.

Secure system(s) 194 can communicate one or more application identifiers, one or more process identifiers, output of one or more executed tasks, output of one or more executed threads, or one or more combinations thereof to one or more application processes external to secure system(s) 194 using one or more interfaces, one or more protocols, and one or more interface mediums.

Secure system(s) 194 can use one or more interfaces, one or more protocols, one or more interface mediums, or one or more combinations thereof to communicate tasks, threads, or both with one or more units of memory using data transfer logic 218 of a bridge, bus, bridge bus, DMA controller, or one or more combinations thereof.

Secure system(s) 194 can use one or more interfaces, one or more protocols, one or more one or more interface mediums, or one or more combinations thereof to communicate tasks, threads, or both with one or more regions of memory using data transfer logic 218 of a bridge, bus, bridge bus, DMA controller, or one or more combinations thereof.

Secure system(s) 194 can use one or more interfaces, one or more protocols, one or more interface mediums, or one or more combinations thereof to communicate one or more application identifiers, one or more process identifiers, output of one or more executed tasks, output of one or more executed threads, or one or more combinations thereof with one or more units of memory using data transfer logic 218 of a bridge, bus, bridge bus, DMA controller, or one or more combinations thereof.

Secure system(s) 194 can use one or more interfaces, one or more protocols, one or more one or more interface mediums, or one or more combinations thereof to communicate one or more application identifiers, one or more process identifiers, output of one or more executed tasks, output of one or more executed threads, or one or more combinations thereof with one or more regions of memory using data transfer logic 218 of a bridge, bus, bridge bus, DMA controller, or one or more combinations thereof.

Applications, application programs, application processes, application data, application process data can be classified, categorized, or both as sensitive. Applications, application programs, application processes, application data, application process data can be determined to be sensitive and classified, categorized, or both as sensitive at any time prior to and during runtime. One or more processes or additional processes can be assigned or resourced in response. Logger 196 comprises one or more logging facilities with each facility configured to monitor a message type or message types, filter all messages of a message type or select messages of a message type based on criterion or criteria, and store the filtered messages.

Wallet and operations management controller and interfaces 198 can communicate with secure system(s) 194 and operations management systems 192 using one or more interfaces, one or more interface mediums, or both. Wallet and operations management controller interfaces 198 can comprise instructions for communicating with operations management systems 192, secure systems 194, or both using one or more protocols, one or more link addresses, such as a Medium Access Control (MAC) address, one or more network addresses, one or more transport identifiers, one or more application identifiers, or one or more combinations thereof.

OS(s) 200 can comprise one or more kernel(s) compiled for use with CISC architecture or RISC architecture. OS(s) can comprise one or more kernels cross compiled for use with CISC architecture and RISC architecture.

Bootloader system 202, e.g., UEFI, can enable one or more OS bootloaders, e.g., A through C, for each OS installed on system device 104. Each OS bootloader, A through C, enables a root partition file system of an OS and executes init which in turn directly or indirectly spawns selected system applications, user applications, etc. One or more OS bootloaders, e.g., A through C, can be a secure OS bootloader. One or more of the OS bootloaders can be operated from one or more RoT. Each secure bootloader encrypts and decrypts an associated OS image using cryptographic algorithms and accelerators. Each secure bootloader authenticates each OS image and verifies the image's integrity using the cryptographic algorithms and accelerators.

Data store(s) 194 can comprise one or more applications, one or more file systems, one or more databases, or one or more combinations thereof installed on one or more partitions of RAM, one or more partitions of non-volatile memory, one or more file system partitions, or one or more combinations thereof. Data store 194 can instantiate and execute one or more applications, one or more databases, or both loaded on one or more partitions of RAM, one or more partitions of non-volatile memory, or one or more combinations thereof.

Data store(s) 194 can communicate with the one or more file systems, one or more databases, or one or more combinations thereof using one or more device identifiers, one or more network addresses, one or more loopback addresses, one or more transport identifiers, one or more application identifiers, one or more application process identifiers, one or more interfaces, one or more protocols, one or more interface mediums, or one or more combinations thereof.

Data store(s) 194 can communicate with one or more user applications, one or more system applications, one or more group applications using one or more device identifiers, one or more network addresses, one or more loopback addresses, one or more transport identifiers, one or more application identifiers, one or more application process identifiers, one or more interfaces, one or more protocols, one or more interface mediums, or one or more combinations thereof.

AAA 206 comprises one or more applications to authenticate user credentials, system credentials, and group credentials associated with accounts of an OS. AAA 206 also comprises one or more applications to authorize authenticated user credentials, system credentials, and group credentials associated with accounts of an OS. AAA 206 also comprises one or more applications to account for system use of authenticated and authorized user credentials, system credentials, and group credentials associated with accounts of an OS and system credentials, authorizing user credentials and system credentials, and accounting for the use of applications and services.

In-memory processes, data 208 can comprise one or more memory identifiers and for each area of memory associated with an identifier the memory area can comprise tasks, threads, and variables and output of application processes created by or created for various applications and processes of device systems 190. These various applications and processes can include, but are not limited to, one or more applications of secure system(s) 194, interfaces 154, application and system services 210, operations management systems 192, AAA 206, OS(s) 200, wallet and operations management controller and interfaces 198, logger 196, data store 204, compliance controller 172, process security manager 174, domain management services 178, or one or more combinations thereof.

Application and system services 210 comprise various user applications, system applications, modules, device drivers, and files that can be called to access and use one or more service-based tasks in support of one or more calling applications. Application services can include web servers, databases, application servers, network infrastructure, middleware, etc.

System services can include memory management, process scheduling, file system management, device drivers, and security services.

Process security manager 212 can store data, store sensitive data, process data, process sensitive data, communicate data, communicate sensitive data, or one or more combinations thereof. Process security manager 212 can store data, store sensitive data, process data, process sensitive data, communicate data, communicate sensitive data, or combinations thereof pursuant to one or more security domains, one or more standards, one or more rules, one or more policies, one or more procedures, one or more protocols, or one or more combinations thereof.

Process security manager 212 can be used by one or more application programs to store data, store sensitive data, process data, process sensitive data, communicate data, communicate sensitive data, or one or more combinations thereof. Process security manager 212 can be used by one or more applications or application programs to store data, store sensitive data, process data, process sensitive data, communicate data, communicate sensitive data, or combinations thereof pursuant to one or more security domains, one or more standards, one or more rules, one or more policies, one or more procedures, one or more protocols, or one or more combinations thereof.

Process security manager 212 can create a security domain and associate one or more user accounts, one or more system accounts, one or more group accounts, or one or more combinations thereof. Process security manager 212 can comprise one or more application programs to associate one or more applications, application programs, or both to a security domain. Process security manager 212 can associate one or more link identifiers, one or more network identifiers, one or more fully qualified domain names, one or more communication addresses, one or more communication numbers, or one or more combinations thereof to a security domain.

Process security manager 212 can associate one or more location variables, one or more location fields, one or more location rows, or one or more combinations thereof to a security domain. Process security manager 212 can associate one or more proximity variables, one or more proximity fields, one or more proximity rows, or one or more combinations thereof to a security domain. Process security manager 212 can associate one or more access tokens, one or more access privileges, one or more authentication tokens, one or more authorizations, or one or more combinations thereof to a security domain,

Process security manager 212 can perform security checks of user applications, system applications, group applications, data stores, in-memory processes, in-memory variables, or one or more combinations thereof. Process security manager 212 can perform backups of user applications, system applications, group applications, data stores, in-memory processes, in-memory variables, or one or more combinations thereof.

Process security manager 212 can perform security checks of user applications, system applications, group applications, data stores, in-memory processes, in-memory variables, or one or more combinations thereof using use one or more schemas, one or more data sets, one or more trusted data sets, one or more rules, one or more policies, one or more procedures, or one or more combinations thereof. Process security manager 212 can use one or more schemas, one or more trusted data sets, one or more rules, one or more policies, one or more procedures, or one or more combinations thereof for performing data integrity and data quality checks of data set backups.

Process security manager 212 can determine user privileges, system privileges, group privileges, or a combination thereof for user applications, system applications, group applications, data stores, in-memory processes, or one or more combinations thereof. Process security manager 212 can determine data quality, data integrity, or both of user applications, system applications, data stores, in-memory processes, or one or more combinations thereof.

Process security manager 212 can analyze one or more application processes, one or more system processes, one or more device processes, or one or more combinations thereof, and create a behavior analysis profile of one or more user applications, one or more system applications, one or more system devices, one or more user accounts, one or more system accounts, one or more group accounts, or one or more combinations thereof.

Process security manager 212 can enable and disable one or more domains, one or more secure execution environments, or one or more combinations thereof based on one or more designated variables, one or more table entries, or both. Process security manager 212 can enable or disable one or more domains, one or more execution environments, one or more secure execution environments, or one or more combinations thereof using one or more rules, one or more policies, one or more procedures, one or more schemas, one or more data sets, or one or more combinations thereof.

Process security manager 212 can enable and disable one or more domains, one or more secure execution environments, or one or more combinations thereof based on or more variables, one or more rows, one or more fields, one or more tables, or one or more combinations thereof. Process security manager 212 can enable and disable one or more domains, one or more execution environments, one or more secure execution environments, or one or more combinations thereof using one or more schemas, one or more data sets, or one or more combinations thereof based on or more variables, one or more rows, one or more fields, one or more tables, or one or more combinations thereof.

Domain management services 214 can administer access, control access, and set privileges for users, groups, and others based on one or more security domains, one or more schemas, one or more data sets, or one or more combinations thereof. Domain management services 214 can administer access, control access, and set privileges for users, groups, and others based on one or more security domains and one or more variables, a change in one or more variables, one or more fields, one or more table rows, or one or more combinations thereof.

Interfaces 216 can select one or more points of contact and communicate data pursuant to one or more protocols using one or more interface mediums. Data transfer logic 218 comprises address, data, and control logic for one or more buses, one or more bridges, one or more Direct Memory Access (DMA) controllers, or combinations thereof. A bus or bridge can provide means for communicating data between various device components, such as processors, processor cores, microcontrollers, memory, input devices, output devices, and peripherals. A DMA controller can request control of part of a bridge or bus to communicate data between two devices, such as an embedded system and a SoC, a SoC and a Network Interface Card, an embedded system and a TEE.

### Enterprise, Enterprise—Consumer, and 3^{rd} Party System Devices

System 100 can further comprises system device 300, system device 302, system devices 304, system device 310, system device 312, system device 314, system device 316, system device 318, system device 320, system device 322, system device 324, system device 326, system device 328, switch device 330, system device 332, router device 334, switch device 336, router device 338, switch device 340, gaming (system) devices 350A-350Z, and application server (system) device 352, or one or more combinations thereof.

### Network Infrastructure System Devices

Network infrastructure system devices 126 can communicate using one or more interfaces, one or more interface mediums, one or more protocols, one or more security methods and processes, or one or more combinations thereof. Network infrastructure system devices 126 can include a plurality of switch devices 230, router devices 232, or both for managing communications between System Devices and various 3rd party services.

System Devices can include any two or more devices of system 100, including 3^{rd} party devices that implement one or more interfaces, one or more mediums, one or more protocols, or one or more combinations thereof disclosed in reference to system device 102, system device 104, device systems 150, secure system(s) 152, device systems 190, secure system(s) 194, or one or more combinations thereof.

The 3rd party services include, but are not limited to, carrier-based network infrastructure services, acquirer bank services 250, issuer bank services 252, gaming event sponsor services 254, retail credit facility services 256, credit rating services 258, government agency services 260, and data center services 262.

Carrier-based network infrastructure services provide fee-based access to a Wide Area Network (WAN) and its infrastructure. Network infrastructure system devices 140 can communicate using one or more interfaces, one or more interface mediums, one or more protocols, one or more security methods and processes, or one or more combinations thereof.

Network infrastructure system devices 140 can include a plurality of switch devices 234, a plurality of router devices 236, or both for managing communication between System Devices and various 3^{rd} party services.

One or more System Devices can be communicably coupled with one or more service ports though network infrastructure 124. Network infrastructure 124 can be configured as one or more Local Area Networks (LAN), one or more Mobile Area Networks (MAN), one or more Wide Area Networks (WAN), or one or more combinations thereof. The one or more service ports can include standard ports, system generated ports, or both. The ports can be dynamically configured, e.g., in real-time, ports for VPN, IPSec, DNS, DNSSEC, HTTP, HTTPS, IMAP, POP, IMAPS, POP3S, SMTP, SMTPS, WebRTC, WebSocket, IRC, XMPP, MQTT, SIP/SIMPLE, AMQP, RCS, and P2P ports.

Secure area 106 is a highly restricted, access-controlled area for storing equipment and data. Secure area 106 comprises a plurality of service devices 202, e.g., lock boxes, laptops, smartphones, and database system 200. Database system 200 can be used to store sensitive data, such as transactions, exchanges, surveillance data, and reports. Casino service kiosk (ATM) 108 is a casino network computing device that can be used by the wallet client 186 to access services provided by wallet server system 140, access banking services available through ATM (Automated Teller Machine) services, and access casino hospitality services.

Wireless router 114, player device 116, pit boss device 210, service agent device 212, lock box 214, service agent device 216, table device 218, table device 220, table device 222, player device 224, player device 226, player device 228, casino chips 230 each comprise RAN (Radio Access Network) technology, such as Bluetooth, Wi-Fi, WiMAX, Ultra-Wideband (UWB), GSM, UMTS, LTE, 5G NR, or any combination thereof. Wireless router 110 can also include physical ports for connecting devices to the router. In some aspects, wireless router 110 includes a gateway device for performing various data processes.

Player devices 116, 226, and 228 include the same or similar system device and device system setup, i.e., client system components, or a subset of the system components, as that described in reference to device client system 180. The replication of such has been omitted for the sake of brevity. The terms pit boss device, service agent device, and table device can also be referenced herein as Point of Transaction (POT) terminals or Point of Exchange (POE) terminals. Network 124 comprises wireless router 126 for routing IP traffic and gateway device 128 for performing various gateway processes on the IP traffic before routing. The gateway processes may include a network configuration service to configure a domain for private IP traffic. Another gateway process may include a network management service to filter and translate network traffic from public IP addresses to private IP addresses, and vice versa. Another gateway process may include an intrusion detection service to filter network traffic based on suspicious activity, a blacklist of IP addresses known for suspicious behavior or various nefarious acts, and policy violations.

The one or more system modules can include, but not limited to, processes to: securely, efficiently, that effectively facilitate, improve, enhance, and add computations and operations related and associated with various casino related services. perform various types of payment transactions

Computing devices, i.e., system devices and network system devices, and each of the device systems create a computing environment hard coded, soft coded, and configured to generate one or more runtime execution environments, one or more secure runtime execution environments, or one or more combinations thereof, and operational to communicably couple with casino based systems and 3^{rd} party service providers systems and manufacture functionality based on various factors to improve, enhance, add to, and secure system operations and system processes.

The one or more secure runtime environments can perform one or more computer operations to instantiate and execute one or more tasks, one or more threads, or one or more combinations thereof in performance of storing sensitive data, credentials, digital chips, reports, transactions, exchanges, evidence, encryption keys, decryption keys, signs, ciphered data, deciphered data, etc.

The one or more secure runtime environments can perform one or more computer operations to instantiate and execute one or more tasks, one or more threads, or one or more combinations thereof in performance of processing sensitive data, credentials, digital chips, reports, transactions, exchanges, evidence, encryption keys, decryption keys, signs, ciphered data, deciphered data, etc.

The one or more secure runtime environments can perform one or more computer operations to instantiate and execute one or more tasks, one or more threads, or one or more combinations in performance of communicating sensitive data, credentials, digital chips, reports, transactions, exchanges, evidence, encryption keys, decryption keys, signs, ciphered data, deciphered data, etc.

The one or more secure runtime environments can perform one or more computer operations to instantiate and execute one or more tasks, one or more threads, or one or more combinations in performance of exchanging sensitive data, credentials, digital chips, reports, transactions, exchanges, evidence, encryption keys, decryption keys, signs, ciphered data, deciphered data, etc.

The one or more secure runtime environments can perform one or more computer operations to instantiate and execute one or more tasks, one or more threads, or one or more combinations in performance of interchanging sensitive data, credentials, digital chips, reports, transactions, exchanges, evidence, encryption keys, decryption keys, signs, ciphered data, deciphered data, etc.

### System Device, Device Systems Profiles

One or more applications or programs of device systems 150 may not be installed for each device of system 100, depending on use case, profile, computing environment, runtime environment, or one or more combinations thereof. One or more installed applications or programs of device systems 150 may not be activated or may be disabled, depending on use case, profile, computing environment, runtime environment, or one or more combinations thereof.

One or more device systems, one or more applications, or one or more programs may be operated as a server, client, headless server, peer-to-peer device, peer-to-peer network, peer-to-peer application, or one or more combinations thereof, depending on use case, profile, or both.

Communication between systems, system devices, device systems, applications, and application processes can be classified and categorized based on use case, profile, computing environment, runtime environment, or one or more combinations thereof.

Asymmetric, symmetric, or hybrid encryption and decryption algorithms can be used to cipher and decipher application layer application processes, process data, or both based on use case, profile, computing environment, runtime environment, or one or more combinations thereof.

Asymmetric, symmetric, or hybrid encryption and decryption algorithms can be used to create one or more Virtual Private Networks (VPNs) by cyphering and deciphering network layer application processes, process data, or both based on use case, profile, computing environment, runtime environment, or one or more combinations thereof.

### Computing Environment and Runtime Environments

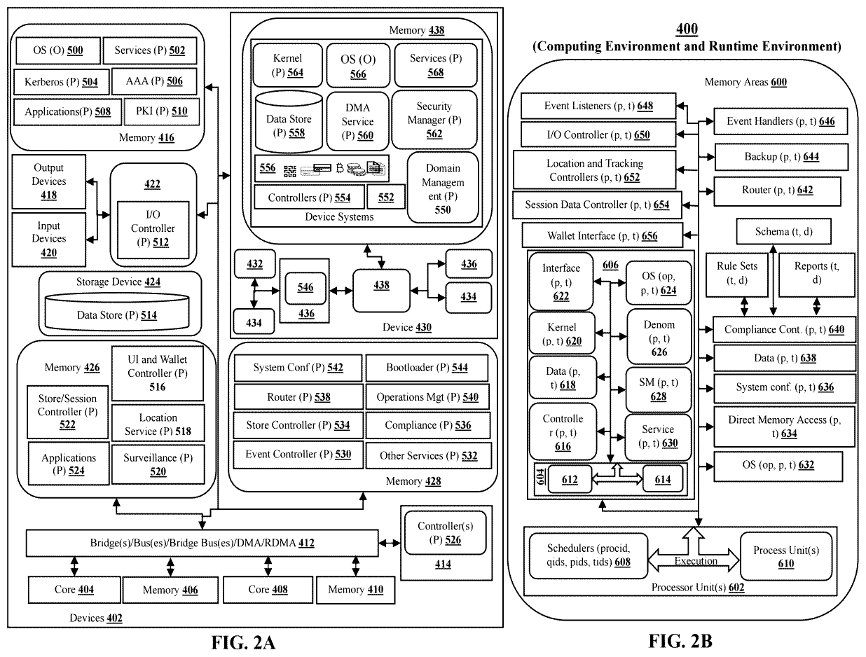

FIG. 2A shows an illustration of a block diagram of a computing environment and its application processes, in accordance with one or more aspects of the present disclosure. FIG. 2B shows an illustration of a block diagram of a runtime execution environment and its tasks and threads, in accordance with one or more aspects of the present disclosure. FIGS. 2A and 2B are denoted generally as 600.

The computing environment of FIG. 2A comprises device system 402, core 404, memory 406, core 408, memory 410, data transfer device 412, DMA device 414, memory 416, memory 422, output devices 418, input devices 420, storage device 424, memory 426, memory 428, devices 430, input device(s) 432, output device(s) 434, memory 436, data transfer device 438, processor 434, memory 436, and memory 438. Data transfer device 412 and data transfer device 428 can comprise bridge(s), bus(es), bridge bus(es), or combinations thereof.

Memory 416 comprises OS (O) 500, services (P) 502, Kerberos (P) 504, AAA (P) 506, applications (P) 508, Public Key Infrastructure (PKI) 510. Memory 422 comprises I/O controller (P) 512. Storage device 424 comprises data store 514. Memory 426 comprises User Interface (UI) and wallet controller (P) 516, location service (P) 518, surveillance (P) 520, store controller and session controller (P) 522, applications (P) 524, and controller(s) (P) 526. Memory 428 comprises event controller (P) 530, other services (P), store controller (P) 534, compliance (P) 536, router (P) 538, operations management (P) 540, system configuration (P) 542, and bootloader (P) 544. Memory 436 comprises I/O controller 546. Memory 438 comprises domain management (P) 550, hardware based, software based, or both symmetric key pairs, hardware based, software based, or both asymmetric keys, or combinations thereof 552, controllers (P) 554, interfaces, interface mediums, and protocols (P) 556, data store (P) 558, DMA service (P) 560, security manager (P) 562, kernel (P) 564, OS (O) 566, and services 568 (P).

The runtime execution environment of FIG. 2B comprises memory area(s) 600, processor unit(s) 602, processor unit(s) 604, and memory area(s) 606. Processor unit(s) 602 comprises scheduler(s) (procid, gids, pids, tids) 608 and process unit(s) 610. Processor unit(s) 604 comprises scheduler(s) (procid, qids, pids, tids) 612 and process unit(s) 614.

Memory areas 606 comprise processor unit(s) 604, controller (p, t) 616, data (p, t) 618, kernel (p, t) 620, interface (p, t) 622, OS (op, p, t) 624, casino chip denominator (p, t) 626, security manager 628, and application or system service (p, t) 630.

Memory areas 600 comprises processor unit(s) 602, processor unit(s) 604, OS (op, p, t) 632, Direct Memory Access (DMA) (p, t) 634, system configuration (p, t) 636, data (p, t) 638, compliance controller (p, t) 640, router (p, t) 642, backup (p, t) 644, event handlers (p, t) 646, event listeners (p, t) 648, I/O controller (p, t) 650, location and tracking controllers (p, t) 652, session data controller (p, t) 654, and wallet interface (p, t) 656.

Computing and runtime environment 400 is a machine coded and configured with instructions to perform one or more processes and methods described herein. The machine may constitute system devices 102, 104, 106, 110, 112, 114, or any combination thereof, upon which one or more device systems, e.g., application servers, application clients, application services, system services, controllers, etc. may perform.

The machine can be coded to process, store, and communicate gaming event related data, credentials data, application data, process data, task data, thread data, and supporting service data. The machine can include various interfaces and protocols for communicating with ATM (service kiosk) 108, wallet server system(s) 140, wallet client system(s) 180, poker chips 230, Point of Transaction (POT) Terminals 114, 210, 212, 214, and 216, table devices 218, 220, and 222, casino gaming machines 120, video poker applications 122, wireless router 110, various internet related services, including one or more trusted third-party systems, or any combination thereof.

The machine comprises processor 304, interconnect bridge and/or bus 306, input devices 308, output devices 310, I/O (Input/Output) interface 312, storage device 314, memory 316, memory 318, and memory 320. Memory 318 comprises user and wallet system interface 325, data store and session controller 326, location services controller 328, application services 330, and system services 332. Memory 320 comprises Isolated wallet system 332 and data store 340. Memory 322 comprises event controller 342, 3^{rd} party services 344, store and session controller 346, and regulation compliance controller 346. Isolated wallet system 332 comprises credentials controller 334, services 335, interface controller 336, and store and session controller 338.

Services 335 can include a limited number of application services and/or system services typically found in an operating system environment. As an example, Kerberos application service tools can be used to prove network authenticity between client and server. PKI (Public Key Infrastructure) application service tools can be used to encrypt and decrypt communications between device applications. System service tools, such as various applications associated with certain hardware (kernel) modules, such as NFC®, Bluetooth®, UWB, etc. Private internet addresses and PKI can be used to create Virtual Private Networks (VPN).

Processor 304 can include without limitation a single processor, such as a microprocessor, or may include a plurality of processors for configuring a device system as a multi-processor system. Processor 204 can be a Central Processing Unit (CPU), a Graphics Processing Unit (GPU), or both. Processor 204 can be a hardware processor core or multiple hardware processor cores.

Memory 216 and 220 can include dynamic memory, static memory, or both and some or all can communicate with each other via bridge and/or bus 206. The bridge can be used for connecting buses and a bus can be used for connecting system components communicably coupled with the bus.

Memory 218 can be a Secure Element (SE). The SE can be implemented in various form factors, such as a Universal Integrated Circuit Card (UICC) or an Embedded Secure Element (eSE). A SE is a tamper-resistance, one-chip microcontroller capable of securely hosting applications and data in accordance with the rules and security requirements established and governed by trusted authorities. Memory 218 can be a Trusted Execution Environment (TEE). A TEE is an allocation of execution space that provides a higher level of security for trusted applications than in a rich Operating System (OS).

A TEE can include hardware-based isolation, attestation mechanisms, secure enclaves, or any combination thereof to create a secure and powerful computing environment for executing sensitive applications. A processor or system-on-chip (SoC) can be configured to include a TEE. The TEE is a secure computing area that can be used to execute code and data. Critical operations, such as secure boot, cryptographic operations, and key management, can be protected against attack.

Input devices 208 and output devices 210 can include several interface devices, and one or more of each device. An interface device can include a keyboard, a touch screen display, a video display, a wireless transceiver, network interface device(s), GPS device(s), card reader, motion sensor, proximity sensor, etc. I/O interface 212 can encode and decode data based on various industry technical standards for connecting, controlling, and communicating with input device 208 and output device 210. The standards can include, as an example, serial, parallel, or other wired or wireless protocols used to connect to, communicate with, or control one or more interface devices.

The standards are created, governed, and distributed by various industry groups for various technologies and applications. The standards include various specifications for devices, services, or both, including, but not limited to, NFC (Near Field Communications), Wi-Fi™, WIMAX®, UWB (Ultra-Wide Band), Cellular Mobile Network Standards, RFID, Bluetooth®, GPS®, Global Platform®, EMVCo®, etc.

Storage device 314 can be a nonvolatile storage device for storing data and/or instructions for use by the processor device 530. Storage device 314 can be implemented, for example, with a magnetic disk drive or an optical disk drive. Storage device 314 can be configured for loading contents of the storage device 340 into memory 318, 320, and 322. Storage device 314 can include a machine-readable medium on which one or more sets of data structures are stored, embodying, or utilized by any one or more features of the applications described herein.

Machine-readable medium can include solid-state memories and optical and magnetic media, and specific examples of commercially available media include non-volatile memory, Electrically Erasable Programmable Read-Only Memory (EEPROM) memory; magnetic disks, Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

Machine readable medium can include a single medium, or multiple media configured to store structured data readable by a digital computer. Machine readable medium can include any medium that can store, encode, or carry software instructions for execution by the machine and that causes the machine to perform any one or more of the techniques of the present disclosure, or that can store, encode or carry data structures used by or associated with such instructions.

The software instructions may also reside, completely or at least partially, within memory 318, 320, and 322, or within processor(s) 304 during execution thereof by one or more of system devices 102, 104, 108, 110, 114, 116, 124, 126, 200, 202, 212, 214, 216, 226, and 228. In an example, one or any combination of processor 304, memory 318, 320, and 322, or storage device 314 may constitute machine readable media.

Instructions may be transmitted or received over a communications network using a transmission medium via I/O interface 312 and input and output devices 308, 310. Computing environment 300 can communicate with one or more other machines utilizing any one of a number of transfer protocols (e.g., frame relay, internet protocol (IP), transmission control protocol (TCP), user datagram protocol (UDP), hypertext transfer protocol (HTTP), etc.).

Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMAX®), IEEE 802.15.4 family of standards, a Long Term Evolution (LTE) family of standards, a Universal Mobile Telecommunications System (UMTS) family of standards, peer-to-peer (P2P) networks, among others.

The machine can operate as a standalone device or can be networked with other machines. In a network system, the machine can operate in the capacity of a server machine, a client machine, or both in server-client network environments. As an example, the machine can operate as a peer machine in peer-to-peer (P2P) (or other distributed) network environment.

The machine can be an application service, network service, personal computer, tablet computer, a set-top box (STB), a personal digital assistant (PDA), a mobile telephone, a smart phone, a web appliance, a network router, switch or bridge, or any machine capable of executing instructions (sequential or otherwise) that specify actions to be taken by that machine.

The machine can execute and instantiate wallet server system 140, wallet client system 180, individual applications thereof, or any combination thereof. The example machine can be implemented as a single machine or a collection of machines. The example machine can be implemented as a distributed computing environment, clustered computing environment, or both. The systems, applications, programs, processes, or combinations thereof of the example machine can be implemented as a distributed computing environment, clustered computing environment, or both. The example machine can execute instructions to perform any one or more of the techniques, processes, or methods discussed herein.

In FIG. 2B, various programs have been executed and instantiated for the purpose of performing various computer operations, tasks, threads, and combinations thereof as described herein in reference to the various illustrative embodiments. As will be understood by one of skill in the art, the illustration of FIGS. 2A and 2B represents several tasks, threads, or both that are queued and executed by one or more processors, one or more processor cores, or both from working memory during a period that includes one or more process instantiations and one or more process executions.

Application instantiations 380 include isolated memory logic 382, wallet system 383, sensitive data 384, stored data variables 386, session/store controller 388, location and tracking controller 390, I/O controller 392, event listeners 394, (F, NV) regulations compliance controller 398, rule sets, federal regulations schema, state regulations schema, and reports for casino's 1 to 4. Each instantiated application, i.e., instantiated user application, includes a unique session identifier and non-session identifier generated by AAA 148, AAA 204, or both in response to a user being granted AAA privileges. The stored data variables 386 can include, but not limited to, data session data and non-session data.

Session data can include data related to the use of the device or wallet client 186 by the user, e.g., wallet registration and activation, gaming event registration and entry, and loading and use of various credit card or debit card credentials. Non-session data can include data associated with the use of the device or wallet application by the user, such as location data, proximity data, and tracking data. Some data, such as facts, may be considered session data and non-session data.

Wallet system 332 can comprise wallet server system 140, wallet client system 180, or both. Wallet system 332 is communicably coupled with memory logic 386. Memory logic 386 is communicably coupled with session store controller 388, location and tracking controller 390, I/O controller 392, event listeners 394, and (F, NV) regulations compliance controller 398.

Memory logic 384 comprises instructions for processing data variables, such as session and non-session data, stored in memory cells, hard drive, or both.

Considering the previously described use case, Chris decided to enter one of the events at the US Poker Open™. As previously stated, Chris also decided to allocate $750k to compete in the tournaments and to satisfy the buy-in requirements, which can range from $20k to $50k.

To register online for one of the tournaments, Chris opens his electronic wallet using user interface and wallet system controller 325. User interface and wallet system controller 325 accesses a file in storage device(s) 314 that includes a set of indexed items. The set of indexed items can include graphics, links, and text. The set of indexed items can be created and updated automatically by the Isolated wallet system 332 after credentials are added or changed in data store 340. The text can include description of the credentials, but description that does not include any sensitive data.

User interface and wallet system controller 325 can display a carousel of credential related text, links, and graphics from which Chris can select. In this case, Chris's electronic wallet includes a preloaded form and link to submit the form, as well as a preloaded form and link to submit funds to satisfy buy-in requirements for tournaments entered. Chris decides to register for one of the tournaments, but he decides to wait and pay the buy-in fee when he arrives at the casino hosting the tournaments.

On the evening of the tournament, Chris arrives at the casino where he is greeted by Carrie. Chris opens his electronic wallet and user interface and wallet system controller 325 displays the carousel of credential related text, completed registration form, entry form, entry form link, and graphics from which Chris can select. Chris selects the entry form which is already populated with data obtained from the registration form and completes the entry form by selecting as a form of payment a graphical representation of a QR code. Associated with the QR code is an identifier and value equal to the buy-in requirement. Chris selects an option to initialize a payment transaction. User interface and wallet system controller 325 encodes a payment initialization command with an authorization token and selected payment method. The payment initialization command is sent to isolated wallet system 332. Isolated wallet system 332 authenticates the authorization token using services 335 and executes credentials controller 334. Isolated wallet system 334 executes and instantiates interface controller 336 and an NFC protocol procedure. At a point when Chris'device and Carrie's device are in proximity, isolated wallet system 332 can receive a transmission request from Carrie's device, generated by Carrie's isolated wallet system in response to a payment request command from Carrie's user interface and wallet system. Credentials controller 334 can authenticate the payment request using services 335 and data store 340. Upon successful authentication, credentials controller 334 encodes a payment message with the entry form and the QR code and sends the payment message to Carrie's device.

### Methods of Operation

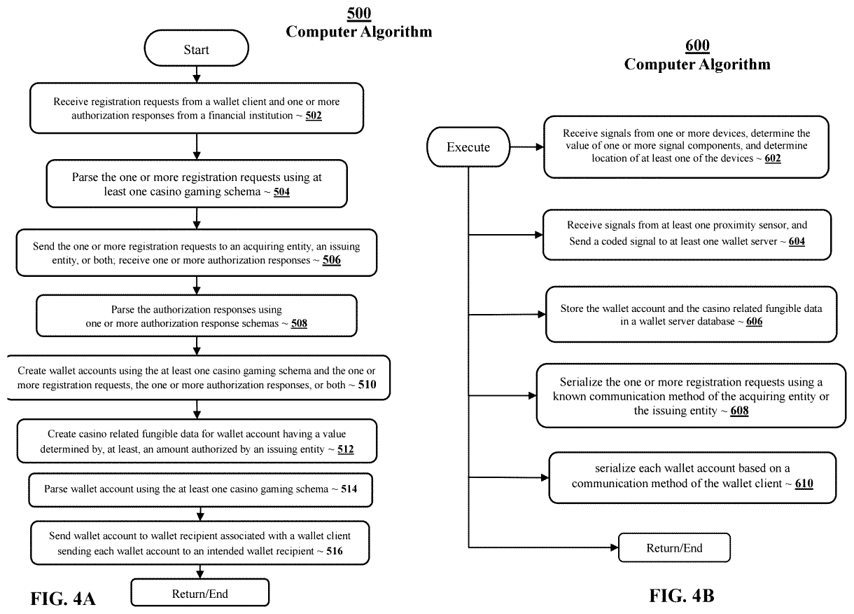

FIG. 4A shows an illustration of a computer algorithm 500 comprising various instructions for performing one or more of the methods and processes disclosed herein, in accordance with one or more aspects of the present disclosure. Computer algorithm 500 can be embodied in one or more of the devices described in reference to FIGS. 1-3.

Computer algorithm 500 starts when it is executed and instantiated within the computer environment 300. Computer algorithm 500 can implement various aspects of the present disclosure in accordance with one or more illustrative embodiments. Some of those aspects are described below.

At block 502, computer algorithm 500 receives registration requests from a wallet client and one or more authorization responses from a financial institution. At block 504, computer algorithm 500 parses the one or more registration requests using at least one casino gaming schema. At block 506, computer algorithm 500 sends the one or more registration requests to an acquiring entity, an issuing entity, or both, and receives one or more authorization responses.

At block 508, computer algorithm 500 parses the one or more authorization responses using one or more authorization response schemas; creating a wallet account for each authorization response using the at least one casino gaming schema and the one or more registration requests, the one or more authorization responses, or both; creating casino related fungible data for each wallet account, the casino related fungible data having a value determined by, at least, an amount authorized by an issuer entity; parsing each wallet account using the at least one casino gaming schema; and sending each wallet account to an intended wallet recipient associated with a wallet client.

FIG. 4B shows an illustration of a computer algorithm 600 having various instructions of computer algorithm 500 for performing one or more of the methods and processes disclosed herein, according to one or more aspects of the present disclosure. Computer algorithm 600 can be embodied in one or more of the devices described in reference to FIGS. 1-3. Computer algorithm 600 comprises programs having instructions executable by the programs of computer algorithm 500. The instructions are configured to perform various tasks of the device systems previously described in reference to FIGS. 1-3. The task can include, but not limited to, processing various signals to determine component values therein, processing or decoding various data to determine values therein, determining location of various devices, determining proximity of various devices, or any combination thereof.

Computer algorithm 600 includes block 602 where transmitted signals from at least one point of exchange or transaction device, at least one proximity sensor device, at least one mobile device, at least one wallet server device, or any combination thereof are received and processed to determine location, distance, proximity, or any combination thereof.

Computer algorithm 600 can process decoded data and determine location, distance, proximity, direction, and speed, or any combination thereof of an object based on the information stored in processed data variables. The object can include a point of transaction device, at least one proximity sensor device, at least one mobile device, the wallet server processor, or any combination thereof. In some embodiments, computer algorithm 600 can measure one or more components of transmitted signals, received signals, or both and encode the data for further processing. The information can include power measurements, angle of orientation of incident wave and reflected wave, time of flight, or any combination thereof.

At block 604, computer algorithm 600 can receive, process, or both signals from at least one proximity sensor, code the signal with a wallet identifier, and send the coded signal to at least one wallet server, wherein the coded signal includes a wallet client identifier, a point of transaction identifier, or both.

At block 606, computer algorithm 600 can store the wallet account and the casino related fungible data in a wallet server database.

At block 608, computer algorithm 600 can serialize the one or more registration requests using a known communication method of acquirer entity or the issuer entity; and serializing each wallet account based on a known communication method of the wallet client.

The casino gaming schema comprises acquirer entity communication protocol variables, acquirer entity processing variables, or both, and at least one selected from a group consisting of a location area identifier, a table identifier, a slot machine identifier, current location identifier, wallet account identifier, account value identifier, debits identifier, credit identifier, and marker identifier.

The casino related fungible data comprise restricted use variables that limit use of the casino related fungible data to a casino, a location area of a casino, specific gaming tables of a casino, specific slot machines of a casino, online gaming applications, or any combination thereof.

### Signaling Diagrams

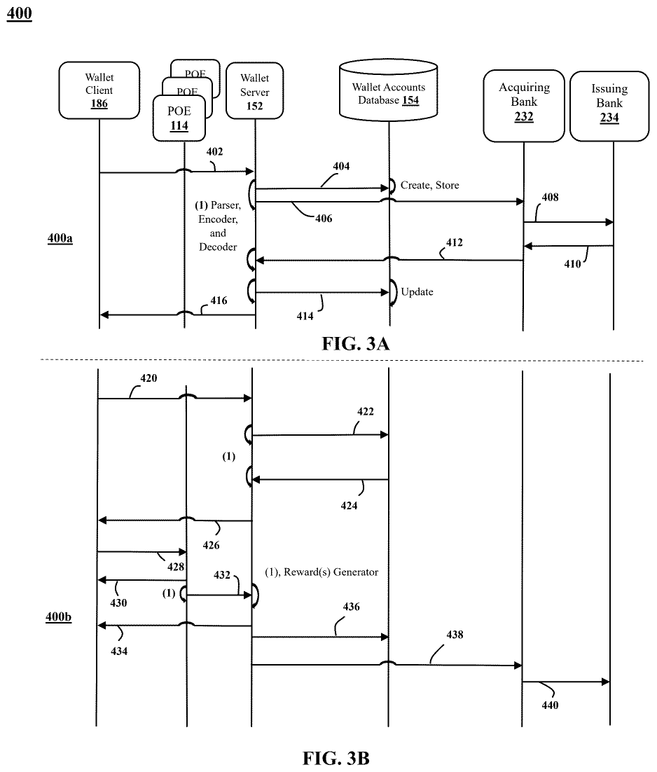

FIG. 3A shows an illustration of a signaling diagram 400a for a process to securely register a player for a gaming tournament using a secure wallet system, transfer electronic funds to the player's wallet account and a casino's wallet account, and tokenize the electronic funds for use in the casino, in accordance with certain aspects of the present disclosure. FIG. 3B shows an illustration of a signaling diagram 400b for entering the player into the gaming tournament using a wallet client and tournament registration information and transferring buy-in funds to the casino's account, in accordance with certain aspects of the present disclosure.

Signaling diagrams 400a and 400b are embodied in wallet client 186, one or more Point of Transaction (POT) terminals, wallet server 152, wallet accounts database 156, acquirer bank 232, issuer bank 234, one or more protocols implemented by the devices, and one or more interfaces implemented by the various device systems. POT terminal is a terminal selected by the player and can include one of the agent devices 114, 212, 214, and 216, pit boss device 210, one of the table devices 218, 220, and 222, or service kiosk (ATM) 108.

Referring now to signaling diagram 400a, wallet client 186 sends a registration message 402 to wallet server 150. Registration message 402 may include a registration type, such as wallet client registration, tournament series registration, or both. Registration message 402 may also include tournament series, tournament event, player credentials, itinerary, etc. Registration message 402 may also include one or more commands directing the wallet server 152 to perform additional actions. Wallet server 152 parses the registration message, encodes database message 404 with the parsed data, or a selection thereof, based on the operating system requirements of the wallet accounts database 154, and sends encoded data to wallets accounts database 154.

Wallet accounts database 154 decodes the encoded data and creates an entry in the casino's wallet accounts table and populates the entry with the player's wallet identifier. The casino's wallet accounts table includes banking information necessary to conduct transactions between wallet clients and the casino. This information is linked to the player's wallet identifier. Additional information from the registration message can also be linked to the stored wallet identifier, such as tournament series, tournament event, player credentials, itinerary, etc.

Included in the registration message is a command to transfer funds from the players bank account to the wallet client's newly created casino account. Wallet server 152 encodes message 404 with a message type (transfer authorization), casino account information, and selected player credentials. Encoded message 404 is sent to acquirer bank 232. Acquirer bank 232 sends transfer request 408 to issuer bank 234. Issuer bank 234 either approves or rejects the request. Response message 410 is generated and sent to acquirer bank 232.

Acquirer bank 232 forwards response message 410, or parts thereof, to wallet server 152. Acquirer bank 232 also updates its account records to reflect the contents of response message 410. Using the decoded contents of response message 410, or parts thereof, wallet server encodes transfer request response message 414 with the decoded contents and sends message 414 to wallet accounts database 154. Wallet accounts database 154 updates the players account using the contents of message 414.

Additionally, registration message 402 may include a tokenization command. In which case, wallet server 152 converts the transferred funds, or a portion of, to casino chips (fungible data items). The funds converted can be included in message 414 for processing and storing by wallet accounts database 154. Wallet server 152 encodes process complete message 416 to reflect the contents of message 414, or a filtered version of message 414, and sends process complete message 416 to wallet client 186 for processing and storing.

Referring now to signaling diagram 400b, wallet client 186 encodes a tournament entry request message 420 with relevant data from its data store. In this case, the relevant data can include, but not limited to, wallet identifier, registration identifier, casino identifier, tournament series identifier, event identifier, or any combination thereof. Wallet client 186 sends tournament entry request message 420 to wallet server 152.

Wallet server 152 parses message 420, encodes entry form receipt message 422 with the parsed data, or component parts thereof, and sends message 422 to wallet accounts database 154 for processing and storing. Wallet accounts database 154 decodes stored data from its database tables, encodes tournament entry receipt message 424 with the decoded data, and sends tournament entry receipt message 424 to wallet server 152. Wallet server 152 decodes tournament entry receipt message 426, encodes a transmittable receipt message 426, and sends message 426 to wallet client 186.

Wallet client 186 parses message 426, encodes the parsed message for storage, and stored the parsed message. Wallet client 186 encodes buy-in request message 428 with stored entry form receipt data and QR code imaging data. The QR code imaging data includes payment transaction data, such as the wallet identifier, selected player credentials, and one or more issuer bank identifiers. Wallet client 186 sends buy-in request message 428 to POE terminal 114. POE terminal 114 parses buy-in request message 428 and encodes transaction information message 430 with a transaction date, such as wallet identifiers, transaction type, date, time, and casino personnel information. Additionally, POE terminal 114 encodes buy-in-exchange message 432 with the parsed data, or at least a portion of the parsed data. POE terminal 114 sends transaction information message 430 to wallet client 186 and sends buy-in-exchange message 432 to wallet server 152.

Wallet server 152 parses message 432, encodes buy-in receipt message 434 with the parsed data, or at least a portion of the data, encodes storage command message 436 with the parsed data, or at least a portion of the data, sends buy-in receipt message 434 to wallet client 186, and sends message 436 to wallet accounts database 154.

In some cases, the casino may offer reward points for payment transactions that exceed a certain dollar amount. In this case, wallet server 152 encodes buy-in receipt message with the rewarded points and encodes storage command message 436 with the rewarded points.

Additionally, wallet server 152 encodes account update message 438 with the reward points and sends message 438 to acquirer bank 232. Acquirer bank 232 parses message 438 and encodes message 440 using the parsed data. Each bank can update their records accordingly using messages 438 and 440.

### Use Case—Player and Personnel Safety

In a practical application, Chris, a professional gambler, has decided to enter one of the events at the US Poker Open™ sponsored by PokerGo® and hosted by a major casino. The cash buy-in requirements in the event tournaments can range from $20k to $50k. Chris decides to allocate $750k to compete in the tournaments and to satisfy the buy-in requirements. Traditionally, Chris would simply enter the event carrying cash, have the cash placed in a security box provided by the sponsor, and use the cash as necessitated by the buy-in requirements.

However, Chris can now download a casino-enabled wallet application and install it on his smartphone. The wallet application is populated with a casino players card and can be populated with other various credentials, such as registration forms, entry forms, bank account, driver's license, bank cards, club cards, etc. The casino-enabled wallet application can be used to securely exchange wallet related data, casino card related data, and the other various credential related data with casino-enabled data exchange network systems, 3rd party systems, or both.

The casino players'card comprises computer instructions coded and configured to process and communicate data with casino-enabled data exchange network systems. The casino-enabled data exchange network systems comprise computer instructions coded and configured to process and communicate data using standard, non-standard, disparate, proprietary, arbitrarily disparate, arbitrarily proprietary, or any combination thereof methods, processes, techniques.

Chris can register for one of the tournaments online, instantiate credentials, and fund his casino players'card. As an example, Chris can download a casino-enabled QR code and use one of the instantiated credentials to fund the QR code with funds sufficient to meet the buy-in requirements needed for entry into the registered contests. At the casino, Chris can exchange the registration form with an entry form using one of the casino's points of exchange (transaction) terminals. Upon arriving at a gaming table, Chris can use his credit card, debit card, bank account, etc. at one of the many casino exchange devices to pay the buy-in fee and obtain his entry form or receipt used to enter the tournament.

By Chris using the casino-enabled wallet application to register, enter, and fund his activities, he has eliminated a possible cause to an effect that could potentially get Chris and others around him injured or worse. Further, security techniques, methods, and processes used obfuscate processing and communications of related data, the data exchanges are secure and free of interception or eavesdropping by nefarious actors. Furthermore, by using isolated computing environments and systematic due diligence to manage processing, storing, and communications of exchange data, these nefarious actors, such as cybercriminals or disgruntled employees, will find the casino-enabled wallet application and data exchange network systems to be highly secure.

### Use Case—Payment Transaction

In reference to the previously described use case, Chris, the professional gambler, has arrived at the casino where he finds one of the service agents named Carrie. Carrie instructs Chris that she needs him to transfer the entry fee of 30k to the casino's wallet account before she can send him his entry form. Chris'wallet client 150 can automatically connect with the casino's private network using the casino's available Wi-Fi® services. As such, Chris'wallet client 186 and Carrie's wallet client belong to a secure common network.

In some cases, while Chris and Carrie are talking, Chris'system device 104 and wallet client 186 establish a connection with Carrie's system device 102 and wallet server 152 using, e.g., Bluetooth®, and exchange non-sensitive information, such as Chris'general contact information, Carrie's general contact information, the Casino's public profile information, tournament information, and hospitality related information.

Chris selects the option to pay the entry fee to the tournament. Wallet client 186 displays a carousel of payment options that can be used. Chris selects a QR code as the payment option and enters the amount to be transacted. Data of an actual QR code is stored in secure wallet system 182. The QR code data is encoded with sensitive data, such as issuer bank information and Chris'bank account information. Wallet client 186 sends a payment request command to secure wallet system 182. The payment request command includes Chris'wallet identifier, the payment option identifier, the amount, and, optionally, information from Carrie's contact information, the casino's public profile information, or any combination thereof.

Chris and Carrie hold their devices next to one another and use the NFC enabled devices to initiate a contactless payment transaction. Alternatively, Chris and Carrie use UWB to securely transact the payment. Secure wallet system 182 parses the transaction initiation command, parses the payment request command, retrieves issuer information and Chris'account information from its secure data store of sensitive information, and encodes the parsed data into a transmittable message. Secure wallet system 182 encodes template data with information from the payment initiation command, e.g., with information that would identify Carrie or the Casino, into a communication message, and sends the message to wallet client 186.

Wallet client 186 parses the message and encodes the message for display. After Chris approves of the transaction, wallet client 186 encodes an approval response and sends the response to secure wallet system 182. Upon processing the approval, secure wallet system 182 sends the transmittable message to Carry's secure wallet system 142.

Carry's secure wallet system 142 can parse the message, retrieve the casino's acquirer bank information, encode the parsed data, or parts thereof, and the acquirer bank information into a transmittable message, and send the transmittable message to the acquirer bank's payment processing system. Once the transaction is approved, wallet client 186 and the wallet server 152 receive an approved transaction receipt. Chris wallet account (account data) and the casino's wallet account are debited and credited accordingly.

### Use Case—Data Security and Regulatory Compliance

In a practical application, a major casino is sponsoring the US Poker Open(TM) in Las Vegas, NV. Several tournaments including several No Limit (NL) Hold'em events are available for entry with a minimum cash buy-in of $25k. Bryan, a professional gambler, has decided to enter one of the NL Hold'em events, and he has decided on allocating $750k for use in the selected tournament.

Bryan has a wallet client application, i.e., wallet client system, installed on his phone that includes a casino players card, casino related forms, casino contact and booking information, driver's license, credit card, bank card, casino chips, and cryptocurrency. Bryan uses the wallet client system to interact with the wallet server application, i.e., the wallet server system, provided by the major casino to register for the US Poker Open(TM) tournament, pay the entry fee, and obtain his entry confirmation.

The wallet client application securely establishes a login session to securely authenticate a username and password with the wallet server system using a highly secure storage and communications apparatus. On positive authentication, the wallet server system authorizes the wallet client application for access to various casino services, such as event registration, buy-in requirements and payments, casino advancements, club card applications, credit card applications, debit card applications, exchange for casino chips, hotel booking, car rental, concierge services, etc.

Upon successful authentication and authorization, the wallet client application can download the wallet server application's registration forms, upload the necessary information, and download the confirmation. Bryan can pay for entry at this time or wait until it is necessary to enter the event. Bryan decides he will wait until he arrives at the casino to pay the entry fee.

Upon arriving at the event, Bryan is greeted by one of the casino's service agents. Bryan learns from the service agent that due to several late cancellations she has been authorized by the casino to offer a comp to certain guests, e.g., registrants with entry fee dues over $20k, that complete their entry. Bryan decides to take advantage of her offer and asks for her wallet identifier.

Bryan sends a secure connection and buy-in payment request to Sabrina's point of exchange application using Sabrina's wallet identifier. In return, Bryan submits his driver's license and confirmation. After Sabrina gives authorization to make payment, the point of exchange application sends an authorization reply and payment request to the wallet client application. Bryan selects one of the means of payment in his client wallet application and sends in response the $25k entry fee to Sabrina's point of exchange application. The authorization response from the acquirer bank, the issuer bank, or both is sent to Sabrina's point of exchange terminal.

Sabrina then causes her point of exchange application to generate the entry form receipt, add the comp, and send the entry form receipt to Bryan. Bryan's wallet client application updates the casino players card to include the comp and the casino related forms to include the receipt.

Sabrina instructs Bryan where to find his table and that his casino chips worth $25k will be delivered to the table shortly. Bryan ends up winning the tournament and clears $76k in proceeds.

The Bank Secrecy Act (BSA), under Title 31, is a federal law that regulates the flow of money through business entities considered financial institutions and does so by imposing operating restrictions on how money transactions are managed. As such, the casino is required to report Bryan's winnings.

After the tournament, the wallet server system transfers the $76k to Bryan's bank account, updates Bryan's wallet account, fills out the necessary reporting form, and sends the completed form to the IRS(R), or do so within the allotted time frame.

### Terminology

Computing environment, as used herein, refers to one or more electronic devices, one or more OSs, one or more applications, or one or more combinations thereof associated with one or more security domains, one or more security profiles, or one or more combinations thereof in one or more states of executing one or more tasks, one or more threads, or one or more combinations thereof at any one period or multiple periods.

Runtime environment or runtime execution environment, as used herein, is a layer that provides the necessary resources and services for an application process to run. It acts as an intermediary between the application and the operating system, handling tasks such as memory management, input/output operations, and interfacing with hardware.

Computer device (“device”), as used herein, refers to one or more electronic circuit boards, e.g., a multilayered printed circuit board, comprising one or more host processors, one or more host processor cores, one or more guest processors, one or more guest processor cores, one or more microcontrollers, one or more embedded systems, one or more ASICs, one or more memory areas, one or more hard drives, one or more input devices, one or more output devices, one or more network devices, one or more device systems, or one or more combinations thereof. Device systems can include one or more host Operating System (OS), one or more guest OS, one or more system applications, one or more user applications, or one or more combinations thereof.

Processor, as used herein, refers to at least one nanoprocessor, at least one microprocessor, at least one digital signal processor, at least one graphics processing unit, or one or more combinations thereof. A processor, as used herein, can comprise one or more processor cores. A guest processor, as used herein, can be a virtual machine that runs on top of a hypervisor and independently of a host OS. In this implementation, the virtual machine runs its own OS as a guest of the host. A guest processor, as used herein, can be a virtual container that shares the kernel with the host OS but isolates applications at the process level.

Microcontroller, as used herein, refers to a computer on a small integrated circuit board that comprises one or more processors, memory, programmable memory, programmable input and output interfaces, AD converter, oscillators, etc. A microcontroller is designed and configured to perform general-purpose control tasks in embedded systems.

Secure Element (SE) is a tamper-resistant chip that stores sensitive data, such as cryptographic keys and performs cryptographic tasks, such as encryption, decryption, and signing. SEs are often implemented in embedded systems and physically isolated from the main processor. A Trusted Platform Module (TPM) is a discrete chip on a computer circuit board separate from the main processor that is designed to perform cryptographic tasks, e.g., encryption, decryption, and signing. A TPM can enhance system security by supporting secure boot processes and protecting keys. A Hardware Security Module (HSM) is a separate hardware component or computing device that provides cryptographic services to other applications.

Embedded system, as used herein, refers to computer systems on an integrated circuit board that are designed and configured to perform specific functions in a larger system. An Application Specific Integrated Circuit (ASIC), as used herein, refers to a chip designed, configured, and optimized for a specific application or task. An ASIC has fixed functionality and is not reprogrammable after manufacturing. A System on a Chip (SoC), as used herein, refers to more advanced and integrated form of a microcontroller, tailored for specific implementations. A SoC can include one or more CPUs, one or more GPUs, memory, storage, and various peripherals (like Wi-Fi, Bluetooth, and other interfaces) on a single chip.

Trusted Execution Environment (TEE), as used herein, refers to a secure execution environment with an OS that relies on hardware features to create a secure area in a processor or processor core and memory to instantiate and execute tasks or threads. ARM TrustZone, Intel SGX (Software Guard Extensions), and AMD SEV (Secure Encrypted Virtualization) are examples of hardware mechanisms that can be used to create secure execution environments.

Computer-readable media is an electronic means of storing data that can be accessed with a general purpose or special purpose computer system. Computer-readable media that store computer-executable instructions are non-transitory computer-readable storage mediums accessible using a media interface (media) and electronic device. Computer-readable mediums that carry computer-executable instructions are transmission media. Thus, by way of example, and not limitation, embodiments of the disclosure can comprise at least two distinctly different kinds of computer-readable mediums: non-transitory computer-readable storage media (devices) and transmission media.

As used herein, non-transitory computer-readable storage medium (storage device) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Network device, as used herein, refers to a Network Interface Card (NIC), also known as a network interface adapter, and can include an ethernet NIC, wireless NIC, fiber optic NIC, or Bluetooth NIC. Network device, as used herein, can also refer to a switch, a bridge, a router, a firewall, a repeater, a gateway, a hub, or a modem.

Input device, as used herein, refers to a keyboard, a mouse, a pen, a sound input device, a device for voice input/recognition, a touch input device, etc. Output device, as used herein, refers to display, speakers, a printer, etc. The devices listed are examples that can be included with one or more system devices described herein. Although others may be used.

Input controller, an output controller, or an Input/Output Controller (IOC), as used herein, refers to a controller protocol stack for a network device, an input device, or an output device. The controller protocol stack can be communicably coupled with a host protocol stack of an OS through a host controller interface. The controller protocol stack can be communicably coupled with a host protocol stack and a guest protocol stack of an OS through a host controller interface. The controller protocol stack can be communicably coupled with a host protocol stack of a host OS through a host controller interface of a host OS and with a guest protocol stack of a guest OS through a guest controller interface of a guest OS.

Operating System (OS), as used herein, comprises basic computer operations, such as an input operation, processing operation, storage operation, and output operation in support of a processor's basic functions. These basic computer operations are carried out in response to one or more instructions associated with a task or a thread.

OS, as used herein, also comprises software instructions that manage the mapping between logical addresses and physical addresses, i.e., actual memory locations, in RAM. It also comprises software instructions that switch the system's operating mode between user and kernel modes as needed for security and resource management. It also comprises software instructions for managing files, memory allocation, process synchronization, scheduling tasks, executing applications, preventing unauthorized access, and controlling or interfacing with peripheral devices, such as guest processors, guest cores, input devices, output devices, and network devices. An OS can include basic computer operations coded and configured for Complex Instruction Set Computer (CISC) architecture or Reduced Instruction Set Computer (RISC) architecture.

Embedded Operating System (EOS) is an operating system designed to work with microcontrollers used in embedded systems. An embedded system can include firmware, an OS, kernel with one or more modules, one or more system applications, one or more user applications, or a combination thereof configured, coded, cross compiled, or a combination thereof for performing one or more specialized tasks, for performing one or more specialized tasks in real-time, or for performing one or more tasks in real-time.

OS kernel or simply kernel, as used herein, refers to kernel space software instructions that allow communication between hardware devices, such as network cards, graphics cards, storage controllers, and the OS. Device drivers are used to handle low-level interactions with hardware components. Device drivers can include, but are not limited to, one or more file system drivers, one or more schedulers, one or more interrupt handlers, one or more system calls and interfaces, one or more network stacks, security modules, or any combination thereof. Modules, as used herein, are object files that contain code that can extend the kernel functionality at runtime. One or more device drivers may be kernel modules.

System application, as used herein, refers to applications to perform one or more low-level tasks independently. Low-level tasks can be functions that are critical and essential for running a computer and its operating system. Example tasks can include, but are not limited to, scheduling processes, securing processes and data, interfacing data over a network interface, running processes, and managing interrupts and system calls.

System service, as used herein, refers to a system application to perform one or more low level tasks for another application authenticated and authorized to use the system service. System applications and system services are kernel space applications.

Services offered can be local or in distributed form. These services can be provided to host applications, guest applications, secure system(s), and remote applications using various interfaces and interface mediums, such as shared memory, Inter-Process Communication (IPC), a local loop, a local network, wide area network, Peer to Peer network, Virtual Private Network (VPNs), or other like mediums or interfaces. The service can include, e.g., a web server process, database process, application server process, network infrastructure process, and middleware process.

Application, as used herein, can refer to software instructions that include an initialization program, configuration variables, support variables, one or more application programs, or a combination thereof. Application program, as used herein, refers to one or more software instructions to perform one or more tasks. Application service, as used herein, refers to a user application program to perform one or more tasks for another application authenticated and authorized to use the application service. Applications and application services are user space applications.

Application process, as used herein, refers to an instance of an application program. An application process can have various states, such as start, ready, running, waiting, and terminated. A task, as used herein, refers to one or more application process instructions that represent a discrete unit of work that can be executed by a processor or processor core. A process can comprise one or more tasks. A routine, as used herein, refers to a reuseable block of code that performs a specific task.

Task, as used herein, comprises a program counter, stack, and registers. A thread, as used herein, comprises multiple tasks. Instantiation or instance, as used herein, refers to application instructions and data stored in a stack memory, heap memory, or both and used during execution of the instructions and data.

Process unit or unit of processing, as used herein, refers to a unit of processing resource utilization and comprises a process task, multiple process threaded tasks (threads), multiple tasks with each task from a different process and in parallel, or one or more combinations thereof.

Processing resource, as used herein, comprises one or more processors, one or more processor cores, one or more microcontrollers, one or more microcontroller cores, one or more TEEs, or one or more combinations thereof.

Middleware, as used herein, refers to applications that enable one or more types of communication or one or more types of connectivity between applications or devices in a computing environment. Middleware can comprise one or more user applications, one or more application services, one or more system applications, one or more system services, or any combination thereof. Connectivity refers to a state of being connected.

Debian, Fedora Linux, Arch Linux, and Ubuntu are examples of consumer client OSs and applications that can be used on mobile devices and desktop devices. Red Hat Enterprise Linux and SUSE Linux Enterprise are examples of commercial server distributions of OSs and applications used with server devices. Microsoft® also provides OSs for use with desktops and server devices.

Firmware, as used herein, refers to software that provides low-level control of a hardware component for a device. It acts as an intermediary between hardware and higher-level OS based software.

Communication, as used herein, refers to a general use term used to describe digital data configured for use in a computing environment. Communicating, as used herein, refers to the act of sending, receiving, or both digital information. To communicate or communicate, as used herein, refers to the capability of sending, receiving, or both.

Communication Interface (“Interface”), as used herein, refers to a point of interaction, e.g., point of contact, logical point of contact, or both, between two devices, systems, applications, or application processes and how the entities communicate digital data, i.e. the protocol or protocols used to communicate. Interfaces and interface protocols can be defined for one or more technologies that include, but are not limited to, USB, WIFI, WIMAX, UWB, NFC, Pipes, IPC interface, Message Queues, Shared Memory, Semaphores, ports, identifiers, and addresses. Interface protocol can include a method or process and instructions to carry out the method or process.

Medium or Interface Medium, as used herein, is a physical, logical, or both channel or means of communicating and can include, and without limitation, data link layer, network layer, Personal Area Network (PAN), Inter-Process Communication (IPC) mechanism, a local loop, a local network, wide area network, Peer to Peer application, Peer to Peer network, Peer to Peer device, or Virtual Private Network (VPN).

Personal Area Network (PAN), as used herein, is a network enabled and operational to connect with devices within a particular security domain and within a range of a few meters. PAN technology, as used herein, is wireless technology used to establish one or more connections with one or more compatible devices and transmit and receive data using RF transmission media. Additionally, the technology can be used to determine a device's location within a range of a few meters, depending on the wireless technology. Depending on wireless technology, the device's location can be determined within a range of a few meters in a two-dimensional area or a 3-dimensional space.

Data, as used herein, can refer to any content that is represented by digital data. Data can be unstructured data or structured data. Unstructured data, as used herein, refers to information that is not in a standard format and can't be easily analyzed or stored in databases. Unstructured data can include text documents, images, videos, and other formats. Unstructured data is not organized in a pre-defined manner and may contain text, dates, numbers, and facts. Structured data is data that has a standardized format and can be easily analyzed and stored in databases. Structured data includes data and its metadata, attribute(s), tag(s), or any combination thereof. Metadata provides context and information about associated data. The associated data can be, as an example, an application or dataset. For an application, context and information details may include, but not limited to, the type of application, e.g., an Artificial Intelligence (AI) application, creation date, author, data source, and data format. If the data source is a data set used for training an algorithm using a Machine Learning (ML) based algorithm, context and information details may include features, labels, and preprocessing steps.

Master Data, as used herein, refers to key information that can be shared across a casino enterprise environment. Applications use master data to facilitate business processes mandatory to casino operations, such as casino security, cyber security, customer relationships, services, organization, market volatility, market strategy, legal, financial risk management, and supply chain management.

Master data is the functional data for business entities. Often it consists of a ‘master list’ of customers, products, partners, etc. This type of data is often considered mission critical for the business, and consistently shares overlap with the business's CDEs, or Critical Data Elements. Master data needs to be shared and accessible across the company, while remaining safe, redundant, and adherent to policies.

Master data is specifically created, managed, and stored such that it can be accessed by various applications for specific business processes or functions. For example, employee master data is created and stored in a manner such that both the organization's human resources, and time-tracking systems can access the same master data, but for different functions.

Transactional Data—Transactional processes are foundational for any given business; all documentation of this core element is Transactional Data. Transactional Data usually operates on a much larger scale than Master Data or Reference Data. This increased volume of data-flow requires greater system efficiency and is managed with care, to ensure customers'PCI (Personal Credit Information) data remains private and compliant.

Transactional Data is typically created, stored, and utilized in operational and/or transactional applications such as banking or purchase transactions. Storage of Transaction Data varies amongst companies, branches, and policies. For a company that is focused on selling a product or service, this usually includes the info of your purchasing and selling activities, such as products, price, sale amount, payment method, etc.

Reference data, as used herein, refers to variables, fields, rows, columns, tables, or combinations thereof that categorize data, correlate data with consistent values, and follow internal and/or external data standards. Reference data can include, e.g., lists of countries, regions, customer segments, languages, currencies, and more.

A hash is created using a hash function and data. A signature is created by encrypting the hash using signer's private key. A certificate and the signature are attached to the data to create digitally signed data. The hash is encrypted using a signer's private key. Digital signature is used to verify that a hash generated using a hash function and data is equal to a hash generated by decrypting the digital signature using signer's public key.

Data store, as used herein, refers to a file system or database software instructions and one or more sets of data stored in one or more storage devices. The data store can be an in-memory data store, e.g., an in-memory database system, enabled and operational from memory rather than a storage device. Data structures, as used herein, refer to the persistent storage of data, database tables, and system files. A variable, as used herein, refers to a container of data temporarily stored in-memory. Variables can be stored in processor registers, scheduler, stack, and heap depending on its state of processing. They are a representation of the arrangement, relationships, and contents of data in a storage device.

Data set, as used herein, refers to one or more database tables with each table having one or more columns and fields and one or more rows. Each column of a table represents a particular attribute, also known as meta data, and each field within each column represents an attribute value. Each row corresponds to a given record of the data set in question. Data sets can also consist of a collection of documents or files.

Database, as used herein, refers to a collection of data organized as a data set of rows and columns. Each column comprises a variable and each row represents a record. Each data set is considered a data store and use of the data store is based on a Database Management System (DBMS). DBMS includes instructions that interact with end users, applications, and the database itself to capture and analyze the data.

Data interchange, as used herein, refers to the act of communicating data within one or more secured zones or domains. The data includes structured, dynamically configurable, link, network, or point controlled internal-internal metadata and its payload data.

Data exchange, as used herein, refers to the act of communicating data between one or more secured zones or domains. The data includes structured, dynamically configurable, link, network, or point controlled internal-external metadata and its payload data. Data exchange, as used herein, also refers to the process of taking data structured under a source schema and transforming it into a target schema, so that the target data is an accurate representation of the source data.

Data quality, as used herein, refers to the state of qualitative or quantitative pieces of information. Data security, as used herein, refers to techniques, methods, and processes used to safeguard digital information from unauthorized access, corruption, or theft during the lifecycle of the data. Data integrity, as used herein, refers to data quality and security. Data profile, as used herein, refers to a rating or rating and characterization assigned to a data set that has been evaluated for adherence to a data quality standard.

Wireless computer networking technologies, as used herein, can refer to one or more wired computer networking technologies, or one or more combinations thereof. using one or more cellular network standards, one or more IEEE 802 standards for wireless networks, or one or more combinations thereof NFC standards cover communications protocols and data exchange formats and are based on existing radio-frequency identification (RFID) standards including ISO/IEC 14443 and FeliCa. The standards include ISO/IEC 18092 and those defined by the NFC Forum. Ultra-Wide Band (UWB), as used herein, is a radio frequency technology communications technology Ultra-wideband communication, as standardized by IEEE 802.15.4 (groups a/f/z), enables very low power communication and very accurate ranging in the license-exempt spectrum.

Security domain, as used herein, can include, but not limited to, one or more policies, e.g., 1st party, second party, 3rd party policies, with one or more regulations, one or more rules, or one or more combinations thereof that are applicable to one or more systems, one or more system devices, one or more device systems, one or more applications, one or more programs, one or more behavior analysis profiles, one or more data profiles, one or more fully qualified domain names, one or more device locations, or one or more combinations thereof.

Location, as used herein, refers to the location of an electronic device determined by using co-ordinates data obtained from the device's Global Positioning System (GPS) receiver or determined by using various signal measurements obtained from the device's radio transceiver to determine the position of an electronic device. Location can be determined from co-ordinates, measurements, provided by 3rd party services, or any combination thereof.

Credential data, as used herein, refers to information associated with a casino-internal account, an external account, or both that can be evaluated to determine user authenticity, application and service authorization, and the grant or denial of user access to the application, service, or both based on one or more policies, procedures, or rules. A unique system identifier generated based on the users'privileges can be used by a user application or system application to access one or more applications in a designated domain and zone.

Payment element, as used herein, refers to a type of credentials data that can include a Primary Account Number (PAN), payment card type, issuing bank information, acquiring bank information, routing number, and currency type. The PAN can include various identifiers, and, if any, personal or additional user provided information. The personal or additional user provided information can be used to determine authenticity of one or more parties and grant authorization that allows one or more other processes to execute. The one or more other processes can be used with other services, including 3^{rd} party services to perform one or more system transaction types. The various identifiers can include identifiers for one or more of each: wallet counts, tokenized accounts, casino chips, casino accounts, checking accounts, saving accounts, loan accounts, QR codes, direct deposits (ACH), direct payments (ACH), casino markers, credit cards, debit cards, crypto currency records, smart contract transactions, ACH checks, gift cards, casino complimentary account, and loyalty cards.

Quick Response (QR) code, as used herein, is a matrix of two-dimensional barcodes. The two-dimensional barcodes comprise black squares, a white background, and fiducial markers. The two-dimensional barcodes are readable by imaging devices, such as cameras, and processed using Reed-Solomon error correction until data can be extracted from patterns found in horizontal and vertical components of the captured image or images.

Encryption and decryption method, as used herein, refers to either symmetric encryption and decryption algorithm or asymmetric encryption and decryption algorithm. Encryption process, as used herein, refers to the steps involved in the encryption of readable data using an encryption method. Encryption method can include Advanced Encryption Standard (AES), Rivest-Shamir-Adleman (RSA), Triple Data Encryption Standard (3DES), Blowfish, and Elliptic Curve Cryptography (ECC). An encryption process can include encrypting readable data using a private key and an encryption method. A decryption process can include decrypting the encrypted data using the private key and a decryption method, in the case symmetric encryption. In the case of symmetric encryption, using a public key and a decryption method. Other encryption and decryption processes include cascade encryption, cascade ciphering, multiple encryption use, encryption multiplexor, cascade encryption, cascade ciphering, multiple encryptions, and superencipherment, or any combination thereof.

Casino-interchange data, as used herein, refers to data that represents a casino chip and a casino chip denomination. Casino-exchange data can be used to make a wager on a particular gaming event, make a wager at a gaming table, or make a wager on a sport event. Casino-interchange data can be used to make a play on a gambling device. Casino-interchange data can be used with an Automated Teller Machine (ATM) to exchange for currency, such as fiat currency or cryptocurrency. Casino-interchange data includes meta data that are used to limit, restrict, maintain, manage, and control the interchange, exchange, and use of based, at least in part, on domains and features of one or more system devices, one or more device systems, or any combination thereof.

Casino-exchange data, as referred to herein, can be used with casino exchange terminals and an appropriate casino exchange interface to exchange for currency, such as fiat currency or cryptocurrency. A wallet client or wallet server along with casino-interchange medium data and appropriate casino exchange media can be used to securely exchange casino-interchange medium data with an ATM, casino interchange terminal, another wallet client, or another wallet server.

Wager, as used herein, includes bets made with cash, chips, or cryptocurrencies, and stakes made with an asset, such as stocks or real estate.

Casino chip network, as used herein, is a secure interface and medium casino chips between wallet applications.

Casino exchange interfaces are data structures used to exchange information with various payment networks and cryptocurrency networks using various protocols.

Payment network interface protocols, as used herein, can include a Unified Payments Interface (UPI), Inter-Ledger Protocol (ILP), Society for Worldwide Interbank Financial Telecommunication (SWIFT), Automated Clearing House (ACH), Credit Card Networks, and Peer-to-Peer Payment Networks.

Cryptocurrency networks, as used here, can include blockchain-based cryptocurrencies, Distributed Ledger Technologies (DLTs), e.g., Hyperledger Fabric and Corda, stablecoins, such as Tether (USDT), USD Coin (USDC), and DAI, Privacy Coins, such as Monero (XMR) and Zcash (ZEC), Smart Contract Platforms, such as Ethereum, Layer 2 Solutions, such as Lightning Network and Polygon, and Central Bank Digital Currencies. Great question! In the context of a Trusted Execution Environment (TEE), “memory encryption” and “memory isolation” refer to broader concepts than just encrypting individual tasks or threads.

Memory encryption, as used herein, refers to encrypting and decrypting data stored in an area of memory to protect it from unauthorized access. The encryption can be applied to an entire area of memory or part of an area of memory used by a TEE. This can ensure that all data or selected data written to or read from the entire area of memory or part of the area of memory are encrypted and decrypted by the processor. The data protected are prevented from being accessed or tampered with by other parts of the system, including the operating system or other applications.

Memory isolation, as used herein, refers to a region of memory isolated from other parts of a system. A TEE can execute selected software instructions, i.e., tasks, threads, and processes, from this region of memory and prevent all other software instructions from using or accessing the isolated region. The terms “memory encryption” and “memory isolation” encompass the protection of the entire memory region used by the TEE, ensuring both confidentiality and integrity of the data.

Peer-to-peer device, as used herein, refers to a device that can be coded and configured to communicate and share resources directly with other devices in a local area network without the use of a central server or user. Each peer-to-peer device can act as both a client and a server. Examples include computers, smartphones, and IoT devices that can communicate directly with each other.

Peer-to-Peer Application, as used herein, refers to an application that can be coded and configured to communicate and share services directly in a local area network and a wide area network. Peer-to-peer applications create virtual networks where each user can share and access files or services from other users. Examples include file-sharing programs like BitTorrent, communication tools like Skype, and blockchain-based applications.

Peer-to-peer (P2P) network, as used herein, refers to a network architecture that can be coded and configured to communicate and share services directly in a local area network and a wide area network with or without a peer-to-peer application or user application. Peers in a P2P network act as both a client and a server, sharing resources directly without relying on a central server.

Roots of Trust (RoT) are highly reliable hardware, firmware, and software components that perform specific, critical security functions. Because roots of trust are inherently trusted, they must be secure by design. A SE, TPM, SoC, and HSM are each considered RoT.

Parsing, as used herein, refers to a process of analyzing a string of symbols to determine its structure and meaning. Encoding, as used herein, refers to a process of converting data from one format to another. Decoding, as used herein, is the process of converting encoded data back into its original format.

Acquirer bank, as used herein, refers to a payment service provider that enables a merchant's transaction to be processed through an authorization and clearing network. Issuer bank, as used herein, refers to a payment service provider that provides a mobile NFC payment service to a customer. Merchant, as used herein, refers to an actor that accepts a mobile NFC payment scheme as payment for goods or services.

Vendor, as used herein, is a person or an entity that provides goods and services to other entities. Third party, as used herein, is an entity, an individual or a company tasked with providing products and services to consumers on behalf of an organization.

Third (3^{rd}) Party, as used herein, can refer to a personal bank, a commercial bank, an investment bank, a loan servicing entity, a credit bureau, a gaming regulatory body, a data center, a carrier, a hosting provider, an application service provider, Nacha, or other like entities. A gaming regulatory body is involved in licensing and regulating casino operations in a jurisdiction. The gaming regulatory body may also license, regulate, and exempt vendors and suppliers to casinos. Gaming event related data can include, but not limited to, forms of payment, primary account number (PAN), means of identifications, registration forms, entry forms, compliance forms, reporting forms, and payment authorization requests.
The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/processes may be performed in parallel or out of sequence or combined into a single step/process. The scope of the claims is intended to broadly cover the disclosed embodiments and any such modification. Further, the following clauses represent additional embodiments of the disclosure and should be considered within the scope of the disclosure.
Clause 1, a system integrated with and communicably coupled with casino related services, the system comprising: a wallet server processor communicably coupled to a wallet server memory, the wallet server memory having one or more registration requests and one or more authorization responses, and comprising a set of instructions that cause the wallet server processor to: parse the one or more registration requests using at least one casino gaming schema; send the one or more registration requests to an acquirer entity, an issuer entity, or both; receive one or more authorization responses; parse the one or more authorization responses using one or more authorization response schemas; create a wallet account for each authorization response using the at least one casino gaming schema and the one or more registration requests, the one or more authorization responses, or both; create casino related fungible data for each wallet account, the casino related fungible data having a value determined by, at least, an amount authorized by an issuer entity; parse each wallet account using the at least one casino gaming schema; and send each wallet account to an intended wallet recipient associated with a wallet client.
Clause 2, the system of clause 1, further comprising: a wireless router processor communicably coupled to a wireless router memory, the wireless router memory having one or more received signals, and comprising a set of instructions that cause the wallet router processor to: measure one or more components of each received signal to determine location of the at least one point of transaction device, at least one proximity sensor device, at least one mobile device, the wallet server processor, or any combination thereof.
Clause 3, the system of any of the preceding clauses, further comprising: a proximity sensor processor communicably coupled to a proximity sensor memory, the proximity sensor memory having one or more received signals, and comprising a set of instructions that cause the proximity sensor processor to: send a coded signal to at least one wallet server, wherein the coded signal includes a wallet client identifier, a point of transaction device identifier, or both.
Clause 4, the system of any of the preceding clauses, wherein the set of instructions cause the wallet server processor to store the wallet account and the casino related fungible data in a wallet server database.
Clause 5, the system of any of the preceding clauses, wherein the set of instructions cause the wallet server processor to: serialize the one or more registration requests using a known communication method of the acquirer entity or the issuer entity; and serialize each wallet account based on a known communication method of the wallet client.
Clause 6, the system of any of the preceding clauses, wherein the casino gaming schema comprises acquirer entity communication protocol variables, acquirer entity processing variables, or both, and at least one selected from a group consisting of: a location area identifier, a table identifier, a slot machine identifier, current location identifier, wallet account identifier, account value identifier, debits identifier, credit identifier, and marker identifier.
Clause 7, the system of any of the preceding clauses, wherein the casino related fungible data comprise restricted use variables that limit use of the casino related fungible data to a casino, a location area of a casino, specific gaming tables of a casino, specific slot machines of a casino, online gaming applications, or any combination thereof.
Clause 8, a method of a system integrated with and communicably coupled with casino related services, the method comprising: receiving registration requests from a wallet client and one or more authorization responses from a financial institution; parsing the one or more registration requests using at least one casino gaming schema; sending the one or more registration requests to an acquirer entity, an issuer entity, or both; receiving one or more authorization responses; parsing the one or more authorization responses using one or more authorization response schemas; creating a wallet account for each authorization response using the at least one casino gaming schema and the one or more registration requests, the one or more authorization responses, or both; creating casino related fungible data for each wallet account, the casino related fungible data having a value determined by, at least, an amount authorized by an issuer entity; parsing each wallet account using the at least one casino gaming schema; and sending each wallet account to an intended wallet recipient associated with a wallet client.
Clause 9, the method of any of the preceding clauses, further comprising: receiving transmitted signals from at least one point of transaction device, at least one proximity sensor device, at least one mobile device, at least one wallet server processor, or any combination thereof; measuring one or more components of each received signal; determining location of the at least one point of transaction device, at least one proximity sensor device, at least one mobile device, the wallet server processor, or any combination thereof.
Clause 10, the method of any of the preceding clauses, further comprising: receiving signals from at least one proximity sensor; sending a coded signal to at least one wallet server, wherein the coded signal includes a wallet client identifier, a point of transaction identifier, or both.
Clause 11, the method of any of the preceding clauses, further comprising storing the wallet account and the casino related fungible data in a wallet server database.
Clause 12, the method of any of the preceding clauses, further comprising: serializing the one or more registration requests using a known communication method of the acquirer entity or the issuer entity; and serializing each wallet account based on a known communication method of the wallet client.
Clause 13, the method of any of the preceding clauses, wherein the casino gaming schema comprises acquirer entity communication protocol variables, acquirer entity processing variables, or both, and at least one selected from a group consisting of: a location area identifier, a table identifier, a slot machine identifier, current location identifier, wallet account identifier, account value identifier, debits identifier, credit identifier, and marker identifier.
Clause 14, the method of any of the preceding clauses, wherein the casino related fungible data comprise restricted use variables that limit use of the casino related fungible data to a casino, a location area of a casino, specific gaming tables of a casino, specific slot machines of a casino, online gaming applications, or any combination thereof.
Clause 15, a device integrated with and communicably coupled with casino related services, the device comprising: a processing unit; and system memory comprising instructions which, when executed by the processing unit, cause the processing unit to: receive registration requests from a wallet client and one or more authorization responses from a financial institution; parse the one or more registration requests using at least one casino gaming schema; send the one or more registration requests to an acquirer entity, an issuer entity, or both; receive one or more authorization responses; parse the one or more authorization responses using one or more authorization response schemas; create a wallet account for each authorization response using the at least one casino gaming schema and the one or more registration requests, the one or more authorization responses, or both; create casino related fungible data for each wallet account, the casino related fungible data having a value determined by, at least, an amount authorized by an issuer entity; parse each wallet account using the at least one casino gaming schema; and send each wallet account to an intended wallet recipient associated with a wallet client.
Clause 16, the device of any of the preceding clauses, further comprising instructions which, when executed by the processing unit, cause the processing unit to: receive transmitted signals from at least one point of transaction device, at least one proximity sensor device, at least one mobile device, at least one wallet server processor, or any combination thereof; measure one or more components of each received signal; determine location of the at least one point of transaction device, at least one proximity sensor device, at least one mobile device, the wallet server processor, or any combination thereof.
Clause 17, the device of any of the preceding clauses, further comprising instructions which, when executed by the processing unit, cause the processing unit to: receive signals from at least one proximity sensor; send a coded signal to at least one wallet server, wherein the coded signal includes a wallet client identifier, a point of transaction identifier, or both.
Clause 18, the device of any of the preceding clauses, further comprising instructions which, when executed by the processing unit, cause the processing unit to store the wallet account and the casino related fungible data in a wallet server database.
Clause 19, the device of any of the preceding clauses, further comprising instructions which, when executed by the processing unit, cause the processing unit to: serialize the one or more registration requests using a known communication method of the acquirer entity or the issuer entity; and serialize each wallet account based on a known communication method of the wallet client.
Clause 20, the device of any of the preceding clauses, wherein the casino gaming schema comprises acquirer entity communication protocol variables, acquirer entity processing variables, or both, and at least one selected from a group consisting of: a location area identifier, a table identifier, a slot machine identifier, current location identifier, wallet account identifier, account value identifier, debits identifier, credit identifier, and marker identifier.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

What is claimed is:

1. A wallet system communicably coupled with one or more operation management systems, the wallet system comprising:
a processor communicably coupled to memory, the memory having one or more registration requests and one or more authorization responses, and comprising a set of instructions that cause the processor to:
parse the one or more registration requests using at least one casino gaming schema;
send the one or more registration requests to an acquirer entity, an issuer entity, or both;
receive one or more authorization responses;
parse the one or more authorization responses using one or more authorization response schemas;
create a wallet account for each authorization response using the at least one casino gaming schema and the one or more registration requests, the one or more authorization responses, or both;
create casino related fungible data for each wallet account, the casino related fungible data having a value determined by, at least, an amount authorized by an issuer entity;
parse each wallet account using the at least one casino gaming schema; and
send each wallet account to an intended wallet recipient associated with a wallet client.

2. The system of claim 1, further comprising:
a wireless router processor communicably coupled to a wireless router memory, the wireless router memory having one or more received signals, and comprising a set of instructions that cause the wallet router processor to:
measure one or more components of each received signal to determine location of the at least one point of transaction device, at least one proximity sensor device, at least one mobile device, the wallet server processor, or any combination thereof.

3. The system of claim 1, further comprising:
a proximity sensor processor communicably coupled to a proximity sensor memory, the proximity sensor memory having one or more received signals, and comprising a set of instructions that cause the proximity sensor processor to:
send a coded signal to at least one wallet server, wherein the coded signal includes a wallet client identifier, a point of transaction device identifier, or both.

4. The system of claim 1, wherein the set of instructions cause the wallet server processor to store the wallet account and the casino related fungible data in a wallet server database.

5. The system of claim 1, wherein the set of instructions cause the wallet server processor to:
serialize the one or more registration requests using a known communication method of the acquirer entity or the issuer entity; and
serialize each wallet account based on a known communication method of the wallet client.

6. The system of claim 1, wherein the casino gaming schema comprises acquirer entity communication protocol variables, acquirer entity processing variables, or both, and at least one selected from a group consisting of: a location area identifier, a table identifier, a slot machine identifier, current location identifier, wallet account identifier, account value identifier, debits identifier, credit identifier, and marker identifier.

7. The system of claim 1, wherein the casino related fungible data comprise restricted use variables that limit use of the casino related fungible data to a casino, a location area of a casino, specific gaming tables of a casino, specific slot machines of a casino, online gaming applications, or any combination thereof.

8. A method of a system integrated with and communicably coupled with casino related services, the method comprising:
receiving registration requests from a wallet client and one or more authorization responses from a financial institution;
parsing the one or more registration requests using at least one casino gaming schema;
sending the one or more registration requests to an acquirer entity, an issuer entity, or both;
receiving one or more authorization responses;
parsing the one or more authorization responses using one or more authorization response schemas;
creating a wallet account for each authorization response using the at least one casino gaming schema and the one or more registration requests, the one or more authorization responses, or both;
creating casino related fungible data for each wallet account, the casino related fungible data having a value determined by, at least, an amount authorized by an issuer entity;
parsing each wallet account using the at least one casino gaming schema; and
sending each wallet account to an intended wallet recipient associated with a wallet client.

9. The method of claim 8, further comprising:
receiving transmitted signals from at least one point of transaction device, at least one proximity sensor device, at least one mobile device, at least one wallet server processor, or any combination thereof;
measuring one or more components of each received signal;
determining location of the at least one point of transaction device, at least one proximity sensor device, at least one mobile device, the wallet server processor, or any combination thereof.

10. The method of claim 1, further comprising:
receiving signals from at least one proximity sensor;
sending a coded signal to at least one wallet server, wherein the coded signal includes a wallet client identifier, a point of transaction identifier, or both.

11. The method of claim 1, further comprising storing the wallet account and the casino related fungible data in a wallet server database.

12. The method of claim 1, further comprising:
serializing the one or more registration requests using a known communication method of the acquirer entity or the issuer entity; and
serializing each wallet account based on a known communication method of the wallet client.

13. The method of claim 1, wherein the casino gaming schema comprises acquirer entity communication protocol variables, acquirer entity processing variables, or both, and at least one selected from a group consisting of: a location area identifier, a table identifier, a slot machine identifier, current location identifier, wallet account identifier, account value identifier, debits identifier, credit identifier, and marker identifier.

14. The method of claim 1, wherein the casino related fungible data comprise restricted use variables that limit use of the casino related fungible data to a casino, a location area of a casino, specific gaming tables of a casino, specific slot machines of a casino, online gaming applications, or any combination thereof.

15. A device integrated with and communicably coupled with casino related services, the device comprising:
a processing unit; and
system memory comprising instructions which, when executed by the processing unit, cause the processing unit to:
receive registration requests from a wallet client and one or more authorization responses from a financial institution;
parse the one or more registration requests using at least one casino gaming schema;
send the one or more registration requests to an acquirer entity, an issuer entity, or both;
receive one or more authorization responses;
parse the one or more authorization responses using one or more authorization response schemas;
create a wallet account for each authorization response using the at least one casino gaming schema and the one or more registration requests, the one or more authorization responses, or both;
create casino related fungible data for each wallet account, the casino related fungible data having a value determined by, at least, an amount authorized by an issuer entity;
parse each wallet account using the at least one casino gaming schema; and
send each wallet account to an intended wallet recipient associated with a wallet client.

16. The device of claim 15, further comprising instructions which, when executed by the processing unit, cause the processing unit to:
receive transmitted signals from at least one point of transaction device, at least one proximity sensor device, at least one mobile device, at least one wallet server processor, or any combination thereof;
measure one or more components of each received signal;
determine location of the at least one point of transaction device, at least one proximity sensor device, at least one mobile device, the wallet server processor, or any combination thereof.

17. The device of claim 15, further comprising instructions which, when executed by the processing unit, cause the processing unit to:
receive signals from at least one proximity sensor;
send a coded signal to at least one wallet server, wherein the coded signal includes a wallet client identifier, a point of transaction identifier, or both.

18. The device of claim 15, further comprising instructions which, when executed by the processing unit, cause the processing unit to store the wallet account and the casino related fungible data in a wallet server database.

19. The device of claim 15, further comprising instructions which, when executed by the processing unit, cause the processing unit to:
serialize the one or more registration requests using a known communication method of the acquirer entity or the issuer entity; and
serialize each wallet account based on a known communication method of the wallet client.

20. The device of claim 15, wherein the casino gaming schema comprises acquirer entity communication protocol variables, acquirer entity processing variables, or both, and at least one selected from a group consisting of: a location area identifier, a table identifier, a slot machine identifier, current location identifier, wallet account identifier, account value identifier, debits identifier, credit identifier, and marker identifier.
